(19) United States
(12) Patent Application Publication
(10) Pub. No.: US 2019/0130191 A1
(43) Pub. Date: May 2, 2019

(54) BOUNDING BOX SMOOTHING FOR OBJECT TRACKING IN A VIDEO ANALYTICS SYSTEM

(71) Applicant: QUALCOMM Incorporated, San Diego, CA (US)

(72) Inventors: Yang ZHOU, San Jose, CA (US); Ying CHEN, San Diego, CA (US); Chen-Lan Chester YEN, Carlsbad, CA (US)

(21) Appl. No.: 16/159,355

(22) Filed: Oct. 12, 2018

Related U.S. Application Data
(60) Provisional application No. 62/578,995, filed on Oct. 30, 2017.

(51) Int. Cl. G06K 9/00; G06K 9/32

(52) U.S. Cl. CPC G06K 9/00744; G06K 9/00765; G06K 9/3241

(57) ABSTRACT

Techniques and systems are provided for tracking objects in one or more video frames. For example, a candidate bounding box for an object tracker can be obtained based on an application of an object detector to at least one key frame in the one or more video frames, the candidate bounding box being associated with one or more input attributes. A set of metrics indicating a degree of change of one or more physical attributes of the object can also be determined. Based on the set of metrics, it can be determined whether to post-process the input attributes to generate one or more output attributes of a current output bounding box. An object can be tracked in a current frame using the current output bounding box.

### CROSS-REFERENCE TO RELATED APPLICATIONS

This application claims the benefit of U.S. Provisional Application No. 62/578,995, filed Oct. 30, 2017, which is hereby incorporated by reference, in its entirety and for all purposes.

### FIELD

The present disclosure generally relates to video analytics for detecting and tracking objects, and more specifically to techniques and systems for smoothing bounding boxes for object tracking in a video analytics system.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. In some cases, video analytics can send alerts or alarms for certain events of interest. More advanced video analytics is needed to provide efficient and robust video sequence processing.

### BRIEF SUMMARY

In some examples, techniques and systems are described for detecting and tracking objects in images by applying a hybrid video analytics system. The hybrid video analytics system combines blob detection and complex object detection to more accurately detect objects in the images. For example, a blob detection component of a video analytics system can use image data from one or more video frames to generate or identify blobs for the one or more video frames. A blob represents at least a portion of one or more objects in a video frame (also referred to as a “picture”). Blob detection can utilize background subtraction to determine a background portion of a scene and a foreground portion of scene. Blobs can then be detected based on the foreground portion of the scene. Blob bounding regions (e.g., bounding boxes or other bounding region) can be associated with the blobs, in which case a blob and a blob bounding region can be used interchangeably. A blob bounding region is a shape surrounding a blob, and can be used to represent the blob.

A complex object detector can be used to detect (e.g., classify and/or localize) objects in one or more images. In some cases, the complex object detector can be part of a deep learning system and can apply a trained classification network. For instance, the complex object detector can apply a deep learning neural network (also referred to as deep networks and deep neural networks) to identify objects in an image based on past information about similar objects that the detector has learned based on training data (e.g., training data can include images of objects used to train the system). Any suitable type of deep learning network can be used, including convolutional neural networks (CNNs), autoencoders, deep belief nets (DBNs), Recurrent Neural Networks (RNNs), among others. One illustrative example of a deep learning network detector that can be used includes a single-shot object detector (SSD). Another illustrative example of a deep learning network detector that can be used includes a You only look once (YOLO) detector. Any other suitable deep network-based detector can be used.

In some cases, the hybrid video analytics system can apply the complex object detector at a very low frequency, while background subtraction based tracking and detection can be performed for the majority of the frames. For example, the complex object detector can apply neural network-based object detection (e.g., using a trained network) every N frames, with N being determined based on the delay required to process a frame using the deep learning network and the frame rate of the video sequence. Each frame for which the complex object detector is applied is referred to as a key frame. For other frames (non-key frames), blob detection is applied without also applying the complex object detector. An object classified by the complex object detector can be localized using a bounding region (e.g., a bounding box or other bounding region) representing the classified object. A bounding region generated using the complex object detector is referred to herein as a detector bounding region. For key frames, the bounding regions from the neural network-based object detection and the bounding regions from background subtraction can be combined to generate a final set of bounding regions for tracking. For non-key frames, the bounding regions from the key frames can be used to assist in the tracking process.

The final set of bounding regions determined for a video frame (representing blobs in the video frame) can be provided, for example, for blob processing, object tracking, and other video analytics functions. For example, for an object tracker, the system may output one output bounding region per frame for the object over a set of continuous frames using a hybrid scheme, in which case one output bounding region is generated either from a detector bounding region (e.g., for a key frame) or from a blob bounding region (e.g., for a non-key frame). Object tracking can be performed to track the detected blobs and the objects represented by the blobs based on the output bounding regions assigned to the trackers. As another example, a final bounding region of a tracker can be displayed as tracking a tracked blob when certain conditions are met (e.g., the blob has been tracked for a certain number of frames, a certain period of time, and/or other suitable conditions).

The smoothness of the output bounding regions can affect the object tracking. As used herein, the smoothness of an output bounding region can refer to a rate of change in one or more attributes of the output bounding region over a set of continuous frames. The one or more attributes may include, for example, a position of the output bounding region within the frames (e.g., represented by the pixel coordinates of the geometric center of the output bounding region within the frame), a size of the output bounding region (e.g., represented by a width and a height), a shape of the bounding region, or other suitable attribute.

Changes (or rapid changes) in the attributes of the output bounding region leads to a degradation of the smoothness of the output bounding region, which may introduce errors in the tracking of the object. For example, a change in the size of the output bounding region for an object may provide a false indication that the physical size of the object changes. Also, rapid changes in the position of the output bounding region for a moving object may also provide a false indication of the actual speed of movement of the object. Further, in a case where the output bounding region is displayed as a tracked object, the displaying can also be affected by the changes in the attributes of the output bounding region, which may lead to errors in the visual tracking of the object. For example, the rapid changes in the sizes of the output bounding region across frames can lead to the visual appearances of rapid shrinking or expanding of the output bounding region across the frames. Moreover, the rapid changes in the position of the output bounding region can also lead to the visual appearances of shaking of the output bounding region across the frames. In both cases, the visual appearances of rapid shrinking, expansion, and/or shaking of the output bounding region can create unpleasant flickering effects in the displaying of the output bounding region, and can impede the visual tracking of the object (e.g., by a person) using the displayed output bounding region.

The hybrid scheme of output bounding region generation (e.g., based on detector bounding regions for key frames and blob bounding regions for non-key frames) can degrade the smoothness of an output bounding region across a set of continuous frames. For example, the sizes of a detector bounding region generated from a key frame and a blob bounding region generated from a neighboring non-key frame may differ substantially, even though the two bounding regions are generated to track the same object. Moreover, the positions of the detector bounding region and the blob bounding region in the respective key frame and non-key frame may also differ. These differences in bounding regions generated for a same object can degrade the smoothness of the output bounding region tracking that object between the key-frame and non-key frame, which can introduce errors in the tracking of the objects as well as the displaying of the object tracker.

The techniques and systems described herein operate to perform post-processing on a bounding region before the bounding region is output for object tracking in a video frame. The post-processing may include updating the location of the bounding region in the video frame, updating the size and/or shape of the bounding region, any suitable combination thereof, and/or updating other attributes of the bounding region, to reduce a rate of change these attributes of the output bounding region over a set of continuous frames. With the disclosed techniques, a more accurate tracking of an object can be performed using the output bounding region.

According to at least one example, a method of tracking objects in one or more video frames is provided. The method includes obtaining, based on an application of an object detector to at least one key frame in the one or more video frames, a candidate bounding box for an object tracker associated with an object in a current frame, the candidate bounding box being associated with one or more input attributes, wherein the one or more input attributes include at least one of a location or a size of the candidate bounding box; determining a set of metrics indicating a degree of change of one or more physical attributes of the object; determining, based on the set of metrics, one or more output attributes associated with a current output bounding box, the one or more output attributes being determined based on the one or more input attributes associated with the candidate bounding box.

In another example, an apparatus for tracking objects in one or more video frames is provided. The apparatus includes a memory configured to store the one or more video frames; and a processor configured to: obtain, based on an application of an object detector to at least one key frame in the one or more video frames, a candidate bounding box for an object tracker associated with an object in a current frame, the candidate bounding box being associated with one or more input attributes, wherein the one or more input attributes include at least one of a location or a size of the candidate bounding box; determine a set of metrics indicating a degree of change of one or more physical attributes of the object; determine, based on the set of metrics, one or more output attributes associated with a current output bounding box, the one or more output attributes being determined based on the one or more input attributes associated with the candidate bounding box.

In another example, a non-transitory computer-readable medium is provided that has stored thereon instructions that, when executed by one or more processors, cause the one or more processor to: obtain, based on an application of an object detector to at least one key frame in one or more video frames, a candidate bounding box for an object tracker associated with an object in a current frame, the candidate bounding box being associated with one or more input attributes, wherein the one or more input attributes include at least one of a location or a size of the candidate bounding box; determine a set of metrics indicating a degree of change of one or more physical attributes of the object; determine, based on the set of metrics, one or more output attributes associated with a current output bounding box, the one or more output attributes being determined based on the one or more input attributes associated with the candidate bounding box.

In another example, an apparatus for tracking objects in one or more video frames is provided. The apparatus includes means for storing the one or more video frames; means for obtaining, based on an application of an object detector to at least one key frame in the one or more video frames, a candidate bounding box for an object tracker associated with an object in a current frame, the candidate bounding box being associated with one or more input attributes, wherein the one or more input attributes include at least one of a location or a size of the candidate bounding box; means for determining a set of metrics indicating a degree of change of one or more physical attributes of the object; means for determining, based on the set of metrics, one or more output attributes associated with a current output bounding box, the one or more output attributes being determined based on the one or more input attributes associated with the candidate bounding box.

In some aspects, a key frame is a frame from the one or more video frames to which the object detector is applied.

In some aspects, determining the one or more output attributes associated with the current output bounding box includes selecting the one or more output attributes from the one or more input attributes associated with the candidate bounding box

In some aspects, determining the set of metrics comprises determining a status of the object tracker, and wherein determining the one or more output attributes associated with the current output bounding box comprises: determining whether the status of the object tracker satisfies a pre-determined condition; and based on determining that a status of the object tracker does not satisfy the pre-determined condition, selecting the one or more output attributes from the one or more input attributes associated with the candidate bounding box.

In some aspects, the status of the object tracker comprises a recent status of the object tracker in a most recent previous frame of the one or more video frames, the most recent previous frame being associated with a historical attribute for a historical output bounding box for the object tracker. Determining whether the status of the object tracker satisfies the pre-determined condition may comprise determining whether the object tracker has been continuously associated with the object for at least a threshold duration before the most recent previous frame.

In some aspects, determining the one or more output attributes associated with the current output bounding box further comprises, based on a determination that the object tracker has not been continuously associated with the object for at least the threshold duration before the most recent previous frame, selecting the one or more output attributes from the one or more input attributes associated with the candidate bounding box.

In some aspects, the status of the object tracker comprises an aggregate status of the object tracker across a set of previous frames of the one or more video frames, each previous frame of the set of previous frames being associated with a historical attribute for a historical output bounding box for the object. Determining whether the status of the object tracker satisfies the pre-determined condition may comprise determining whether the object tracker has been continuously associated with the object across at least a requisite number of previous frames of the set of previous frames.

In some aspects, determining the one or more output attributes associated with the current output bounding box further comprises: based on a determination that the object tracker has not been continuously associated with the object across the requisite number of previous frames, selecting the one or more output attributes from the one or more input attributes associated with the candidate bounding box.

In some aspects, the methods, apparatuses, and computer-readable medium described above further comprise based on determining that the recent status of the object tracker in the most recent previous frame satisfies the pre-determined condition, storing the one or more output attributes associated with the current output bounding box in a history buffer.

In some aspects, the methods, apparatuses, and computer-readable medium described above further comprise based on determining that the recent status of the object tracker in the most recent previous frame does not satisfy the pre-determined condition, removing the historical attribute from a history buffer.

In some aspects, determining the set of metrics comprises: determining a first historical width and a first historical height of a historical output bounding box for the object tracker in a most recent previous frame of the one or more video frames; and determining a current width and a current height of the candidate bounding box in the current frame. Determining the one or more output attributes associated with the current output bounding box may comprise, based on determining at least one of a width difference between the first historical width and the current width exceeding a width difference threshold, or a height difference between the first historical height and the current height exceeding a height difference threshold, selecting the one or more output attributes from the one or more input attributes associated with the candidate bounding box.

In some aspects, determining the set of metrics comprises: determining a first historical location of a historical output bounding box for the object tracker in a most recent previous frame of the one or more video frames; and determining a current location of the candidate bounding box. In some aspects, determining the one or more output attributes associated with the current output bounding box further comprises: based on determining at least one of a first distance between the first historical location and the current location along a horizontal direction exceeding a first distance threshold, or a second distance between the first historical location and the current location along a vertical direction exceeding a second distance threshold, selecting the one or more output attributes from the one or more input attributes associated with the candidate bounding box.

In some aspects, determining the set of metrics comprises: determining a first historical location of a historical output bounding box for the object tracker in a most recent previous frame of the one or more video frames; determining a second historical location of the historical output bounding box in a least recent previous frame of a pre-determined set of previous frames including the most recent previous frame; determining a current location of the candidate bounding box; and determining at least one of a third distance threshold based on averaging a third distance between the first historical location and the second historical location along a horizontal direction over a number of frames in the pre-determined set of previous frames, or a fourth distance threshold based on averaging a fourth distance between the first historical location and the second historical location along a vertical direction over the number of frames in the pre-determined set of previous frames. In some aspects, determining the one or more output attributes associated with the current output bounding box further comprises, based on determining at least one of a first distance between the first historical location and the current location along the horizontal direction exceeding the third distance threshold, or a second distance between the first historical location and the current location along the vertical direction exceeding the fourth distance threshold, selecting the one or more output attributes from the one or more input attributes associated with the candidate bounding box.

In some aspects, determining the one or more output attributes associated with the current output bounding box includes selecting the one or more output attributes from a result of post-processing of the one or more input attributes. The one or more output attributes associated with the current output bounding box can include at least one of an adjusted location or an adjusted size of the candidate bounding box when selected from the result of the post-processing of the one or more input attribute

In some aspects, the one or more output attributes comprises a location of the current output bounding box. Selecting the one or more output attributes from the result of post-processing the candidate bounding box may comprise: determining a first historical location of a historical output bounding box for the object tracker in a most recent previous frame of the one or more video frames; determining a second historical location of the historical output bounding box in a least recent previous frame of a pre-determined set of previous frames including the most recent previous frame; determining a current location of the candidate bounding box; and determining the location of the current output bounding box based on the current location, the first historical location, and the second historical location.

In some aspects, the one or more output attributes comprises a width and a height of the current output bounding box. Selecting the one or more output attributes from the result of the post-processing the candidate bounding box may comprise: determining a current width and a current height of the candidate bounding box; determining an average historical width and an average historical height of a historical output bounding box for the object across a pre-determined set of previous frames; determining the width of the current output bounding box based on the current width and the average historical width; and determining the height of the current output bounding box based on the current height and the average historical height.

In some aspects, the methods, apparatuses, and computer-readable medium described above further comprise detecting a blob in the current frame using background subtraction, the blob including pixels of at least a portion of the object in the current frame, wherein tracking the object in the current frame includes tracking the blob using the object tracker based on the one or more output attributes.

In some aspects, the object detector comprises a feature-based detector. In some aspects, the object detector is a complex object detector. In some aspects, the object detector is based on a trained classification network.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example of a system including a video source and a video analytics system, in accordance with some examples.

FIG. 2 is an example of a video analytics system processing video frames, in accordance with some examples.

FIG. 3 is a block diagram illustrating an example of a blob detection system, in accordance with some examples.

FIG. 4 is a block diagram illustrating an example of an object tracking system, in accordance with some examples.

FIG. 5A and FIG. 5B are block diagrams illustrating examples of the changing of a state of an object tracker between two frames, in accordance with some examples.

FIG. 6 is a block diagram illustrating an example of a video analytics system including a complex object detector system, in accordance with some examples.

FIG. 7 is a diagram illustrating a more detailed example of the video analytics system of FIG. 6, in accordance with some examples.

FIG. 8A-FIG. 8C are video frames illustrating an example of the degradation in the smoothness of an output bounding box.

FIG. 9A-FIG. 9C are simplified diagrams of the video frames of FIG. 8A-FIG. 8C.

FIG. 10 is a block diagram illustrating an example of a bounding box smoothing system, in accordance with some examples.

FIG. 11 is a diagram illustrating an example of components of the bounding box smoothing system of FIG. 10, in accordance with some examples.

FIG. 12-FIG. 19 are flow charts illustrating processes for performing bounding box smoothing, in accordance with some examples.

FIG. 20-FIG. 24 are images with illustrative tracking results generated by the bounding box smoothing system of FIG. 10, in accordance with some examples.

FIG. 25 is a block diagram illustrating an example of a deep learning network, in accordance with some examples.

FIG. 26 is a block diagram illustrating an example of a convolutional neural network, in accordance with some examples.

FIG. 27A-FIG. 27C are diagrams illustrating an example of a single-shot object detector, in accordance with some examples.

FIG. 28A-FIG. 28C are diagrams illustrating an example of a you only look once (YOLO) detector, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flow chart, a flow diagram, a data flow diagram, a structure diagram, or a block diagram. Although a flow chart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a sequence of video frames from a video source and can process the video sequence to perform a variety of tasks. One example of a video source can include an Internet protocol camera (IP camera) or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of an event of interest and can send an alert or alarm to a central control room to alert a user of the event of interest.

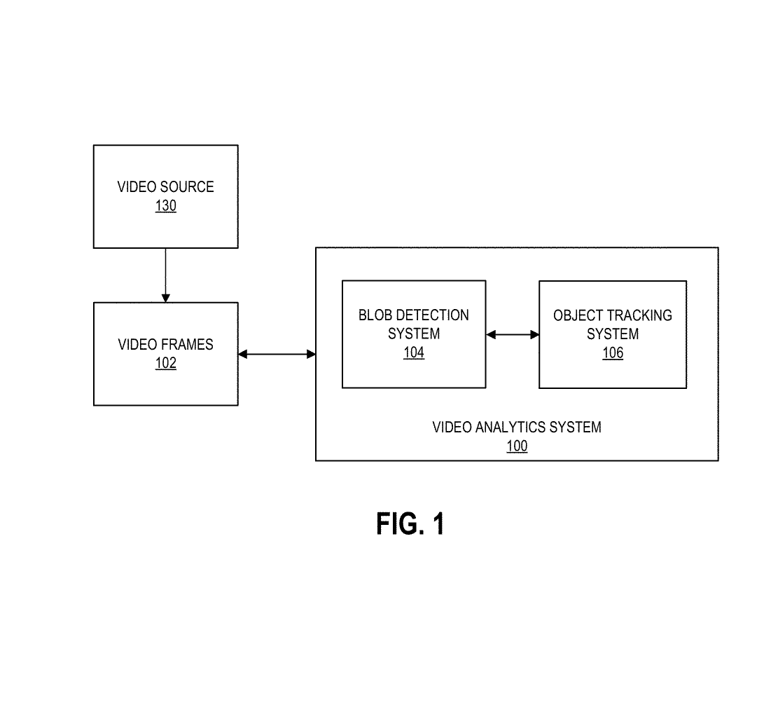

As described in more detail herein, a video analytics system can generate and detect foreground blobs that can be used to perform various operations, such as object tracking (also called blob tracking) and/or the other operations described above. A blob tracker (also referred to as an object tracker) can be used to track one or more blobs in a video sequence using one or more bounding boxes. Details of an example video analytics system with blob detection and object tracking are described below with respect to FIG. 1-FIG. 4.

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection system 104 and an object tracking system 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection system 104 can detect one or more blobs in video frames (e.g., video frames 102) of a video sequence, and the object tracking system 106 can track the one or more blobs across the frames of the video sequence. As used herein, a blob refers to foreground pixels of at least a portion of an object (e.g., a portion of an object or an entire object) in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding box can be associated with a blob. In some examples, a tracker can also be represented by a tracker bounding region. A bounding region of a blob or tracker can include a bounding box, a bounding circle, a bounding ellipse, or any other suitably-shaped region representing a tracker and/or a blob. While examples are described herein using bounding boxes for illustrative purposes, the techniques and systems described herein can also apply using other suitably shaped bounding regions. A bounding box associated with a tracker and/or a blob can have a rectangular shape, a square shape, or other suitable shape. In the tracking layer, in case there is no need to know how the blob is formulated within a bounding box, the term blob and bounding box may be used interchangeably.

As described in more detail below, blobs can be tracked using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of location, of continuous frames, for the blob tracker, as described in more detail below.

In some examples, a motion model for a blob tracker can determine and maintain two locations of the blob tracker for each frame. For example, a first location for a blob tracker for a current frame can include a predicted location in the current frame. The first location is referred to herein as the predicted location. The predicted location of the blob tracker in the current frame includes a location in a previous frame of a blob with which the blob tracker was associated.

Hence, the location of the blob associated with the blob tracker in the previous frame can be used as the predicted location of the blob tracker in the current frame. A second location for the blob tracker for the current frame can include a location in the current frame of a blob with which the tracker is associated in the current frame. The second location is referred to herein as the actual location. Accordingly, the location in the current frame of a blob associated with the blob tracker is used as the actual location of the blob tracker in the current frame. The actual location of the blob tracker in the current frame can be used as the predicted location of the blob tracker in a next frame. The location of the blobs can include the locations of the bounding boxes of the blobs.

The velocity of a blob tracker can include the displacement of a blob tracker between consecutive frames. For example, the displacement can be determined between the centers (or centroids) of two bounding boxes for the blob tracker in two consecutive frames. In one illustrative example, the velocity of a blob tracker can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the tracker in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different overtime (according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

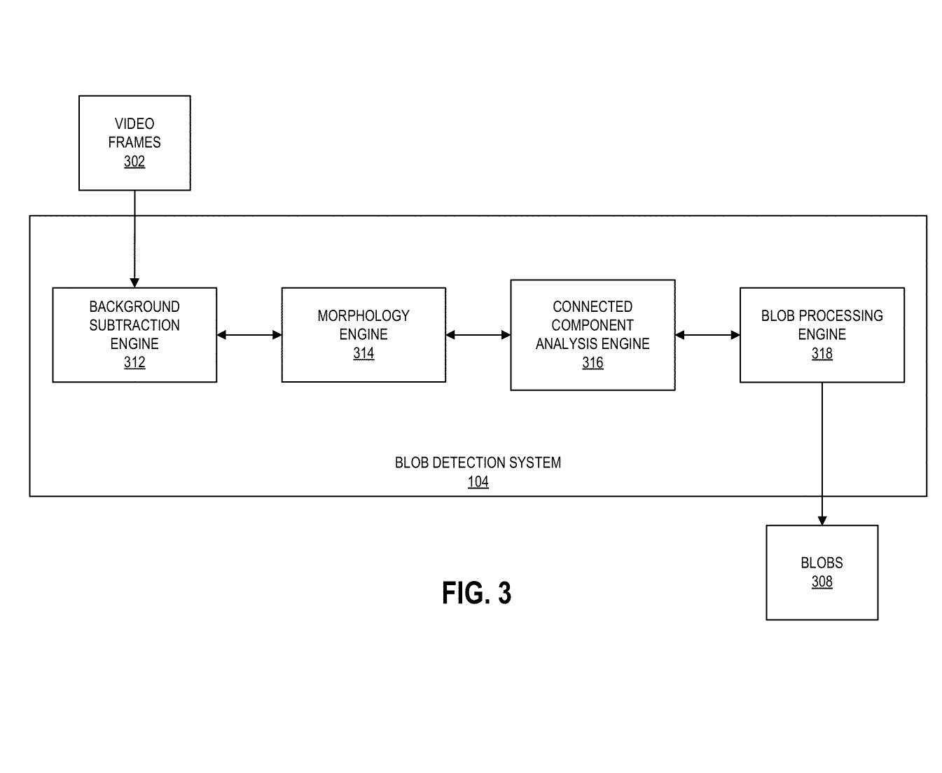

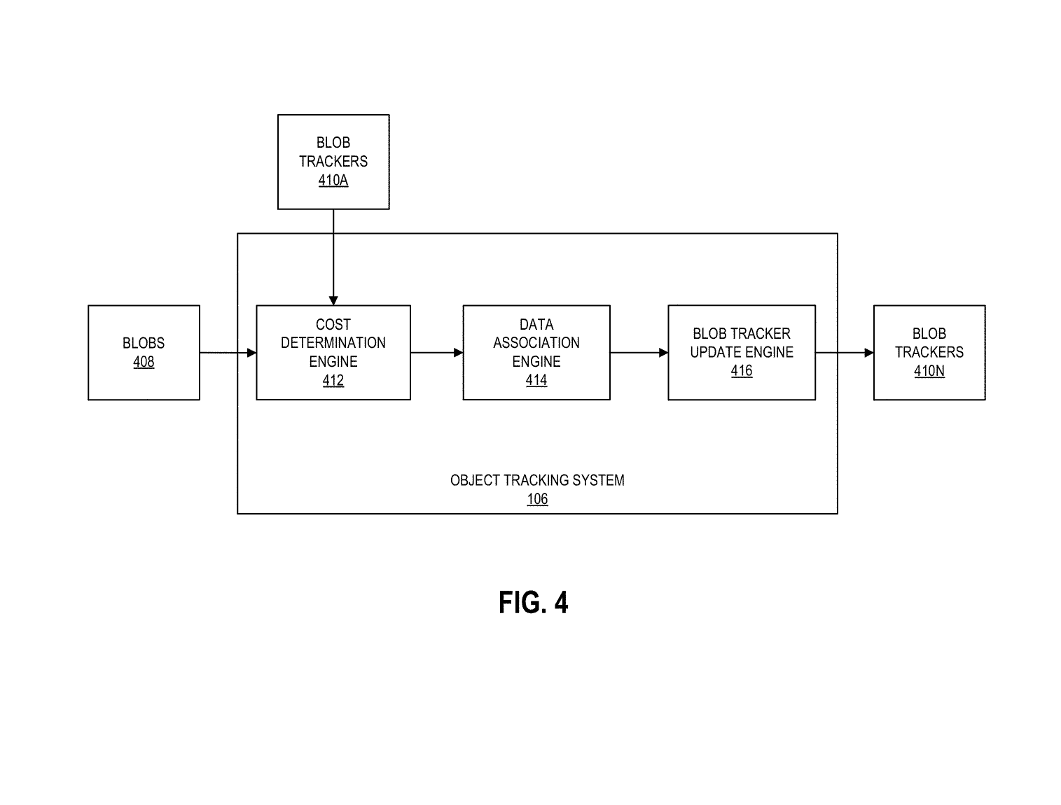

Using the blob detection system 104 and the object tracking system 106, the video analytics system 100 can perform blob generation and detection for each frame or picture of a video sequence. For example, the blob detection system 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection system 104 and the object tracking system 106 are described with respect to FIGS. 3-4.

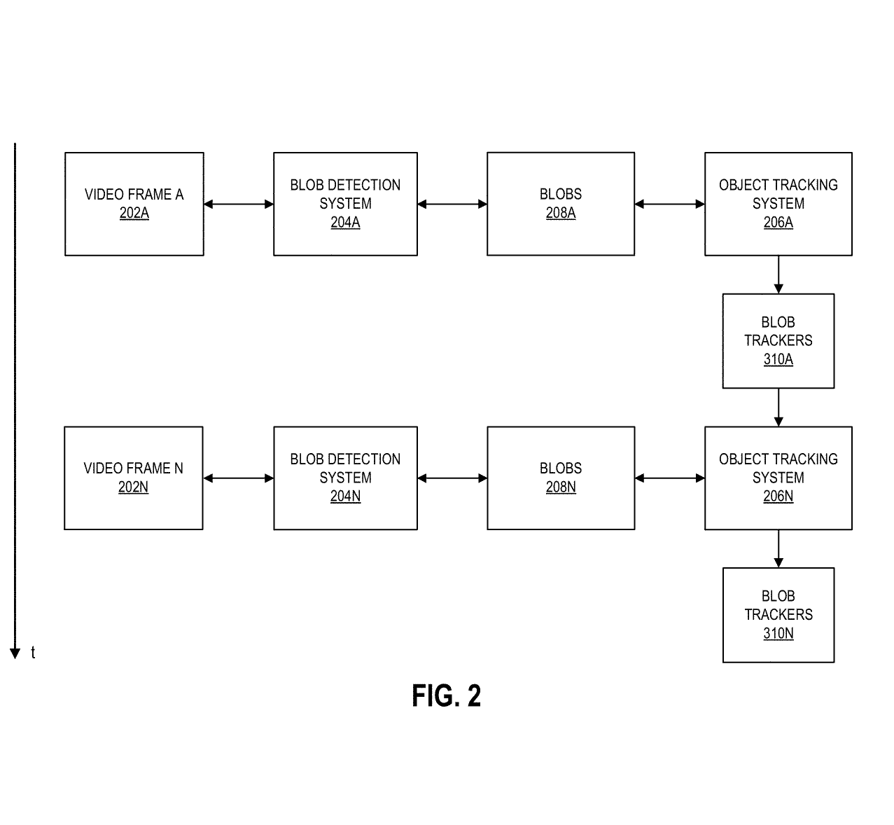

FIG. 2 is an example of the video analytics system (e.g., video analytics system 100) processing video frames across time t. As shown in FIG. 2, a video frame A 202A is received by a blob detection system 204A. The blob detection system 204A generates foreground blobs 208A for the current frame A 202A. After blob detection is performed, the foreground blobs 208A can be used for temporal tracking by the object tracking system 206A. Costs (e.g., a cost including a distance, a weighted distance, or other cost) between blob trackers and blobs can be calculated by the object tracking system 206A. The object tracking system 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob tracker's location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection system 204N generates foreground blobs 208N for the frame N 202N. The object tracking system 206N can then perform temporal tracking of the blobs 208N. For example, the object tracking system 206N obtains the blob trackers 310A that were updated based on the prior video frame A 202A. The object tracking system 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection system 104. Blob detection is used to segment moving objects from the global background in a scene. The blob detection system 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (also referred to as a Gaussian mixture model (GMM)). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

P(Xₜ)=Σᵢ₌₁^{K}ω_{i,t}N(Xₜ|μ_{i,t}, Σ_{i,t}) Equation (1)

An equation of the GMM model is shown in equation (1), wherein there are K Gaussian models. Each Guassian model has a distribution with a mean of μ and variance of Σ, and has a weight ω. Here, i is the index to the Gaussian model and t is the time instance. As shown by the equation, the parameters of the GMM change over time after one frame (at time t) is processed. In GMM or any other learning based background subtraction, the current pixel impacts the whole model of the pixel location based on a learning rate, which could be constant or typically at least the same for each pixel location. A background subtraction method based on GMM (or other learning based background subtraction) adapts to local changes for each pixel. Thus, once a moving object stops, for each pixel location of the object, the same pixel value keeps on contributing to its associated background model heavily, and the region associated with the object becomes background.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with 3×3 window size is called first, and three function calls of dilation of 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. In some implementation of connected component analysis, a set of bounding boxes are returned in a way that each bounding box contains one component of connected pixels. One example of the connected component analysis performed by the connected component analysis engine 316 is implemented as follows:
for each pixel of the foreground mask {
if it is a foreground pixel and has not been processed, the following steps apply:
   Apply FloodFill function to connect this pixel to other foreground and generate a connected component
   Insert the connected component in a list of connected components.
   Mark the pixels in the connected component as being processed

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection system 104. In some examples, there may be a filtering process for the connected components (bounding boxes). For instance, the blob processing engine 318 can perform content-based filtering of certain blobs. In some cases, a machine learning method can determine that a current blob contains noise (e.g., foliage in a scene). Using the machine learning information, the blob processing engine 318 can determine the current blob is a noisy blob and can remove it from the resulting blobs that are provided to the object tracking engine 106. In some cases, the blob processing engine 318 can filter out one or more small blobs that are below a certain size threshold (e.g., an area of a bounding box surrounding a blob is below an area threshold). In some examples, there may be a merging process to merge some connected components (represented as bounding boxes) into bigger bounding boxes. For instance, the blob processing engine 318 can merge close blobs into one big blob to remove the risk of having too many small blobs that could belong to one object. In some cases, two or more bounding boxes may be merged together based on certain rules even when the foreground pixels of the two bounding boxes are totally disconnected. In some embodiments, the blob detection engine 104 does not include the blob processing engine 318, or does not use the blob processing engine 318 in some instances. For example, the blobs generated by the connected component analysis engine 316, without further processing, can be input to the object tracking system 106 to perform blob and/or object tracking.

In some implementations, density based blob area trimming may be performed by the blob processing engine 318. For example, when all blobs have been formulated after post-filtering and before the blobs are input into the tracking layer, the density based blob area trimming can be applied. A similar process is applied vertically and horizontally. For example, the density based blob area trimming can first be performed vertically and then horizontally, or vice versa. The purpose of density based blob area trimming is to filter out the columns (in the vertical process) and/or the rows (in the horizontal process) of a bounding box if the columns or rows only contain a small number of foreground pixels.

The vertical process includes calculating the number of foreground pixels of each column of a bounding box, and denoting the number of foreground pixels as the column density. Then, from the left-most column, columns are processed one by one. The column density of each current column (the column currently being processed) is compared with the maximum column density (the column density of all columns). If the column density of the current column is smaller than a threshold (e.g., a percentage of the maximum column density, such as 10%, 20%, 30%, 50%, or other suitable percentage), the column is removed from the bounding box and the next column is processed. However, once a current column has a column density that is not smaller than the threshold, such a process terminates and the remaining columns are not processed anymore. A similar process can then be applied from the right-most column. One of ordinary skill will appreciate that the vertical process can process the columns beginning with a different column than the left-most column, such as the right-most column or other suitable column in the bounding box.

The horizontal density based blob area trimming process is similar to the vertical process, except the rows of a bounding box are processed instead of columns. For example, the number of foreground pixels of each row of a bounding box is calculated, and is denoted as row density. From the top-most row, the rows are then processed one by one. For each current row (the row currently being processed), the row density is compared with the maximum row density (the row density of all the rows). If the row density of the current row is smaller than a threshold (e.g., a percentage of the maximum row density, such as 10%, 20%, 30%, 50%, or other suitable percentage), the row is removed from the bounding box and the next row is processed. However, once a current row has a row density that is not smaller than the threshold, such a process terminates and the remaining rows are not processed anymore. A similar process can then be applied from the bottom-most row. One of ordinary skill will appreciate that the horizontal process can process the rows beginning with a different row than the top-most row, such as the bottom-most row or other suitable row in the bounding box.

One purpose of the density based blob area trimming is for shadow removal. For example, the density based blob area trimming can be applied when one person is detected together with his or her long and thin shadow in one blob (bounding box). Such a shadow area can be removed after applying density based blob area trimming, since the column density in the shadow area is relatively small. Unlike morphology, which changes the thickness of a blob (besides filtering some isolated foreground pixels from formulating blobs) but roughly preserves the shape of a bounding box, such a density based blob area trimming method can dramatically change the shape of a bounding box.

Once the blobs are detected and processed, object tracking (also referred to as blob tracking) can be performed to track the detected blobs. FIG. 4 is a block diagram illustrating an example of an object tracking engine 106. The input to the blob/object tracking is a list of the blobs 408 (e.g., the bounding boxes of the blobs) generated by the blob detection engine 104. In some cases, a tracker is assigned with a unique ID, and a history of bounding boxes is kept. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking system 106 can obtain the blobs 408 of a current video frame from the blob detection system 104. The cost determination engine 412 can also obtain the blob trackers 410A updated from the previous video frame (e.g., video frame A 202A). A cost function can then be used to calculate costs between the blob trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}=b_{y})²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker (or tracker bounding box) with a corresponding blob (or blob bounding box) and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible. Regardless of the association technique that is used, the data association engine 414 can rely on the distance between the blobs and trackers.

Once the association between the blob trackers 410A and blobs 408 has been completed, the blob tracker update engine 416 can use the information of the associated blobs, as well as the trackers' temporal statuses, to update the status (or states) of the trackers 410A for the current frame. Upon updating the trackers 410A, the blob tracker update engine 416 can perform object tracking using the updated trackers 410N, and can also provide the updated trackers 410N for use in processing a next frame.

The status or state of a blob tracker can include the tracker's identified location (or actual location) in a current frame and its predicted location in the next frame. The location of the foreground blobs are identified by the blob detection engine 104. However, as described in more detail below, the location of a blob tracker in a current frame may need to be predicted based on information from a previous frame (e.g., using a location of a blob associated with the blob tracker in the previous frame). After the data association is performed for the current frame, the tracker location in the current frame can be identified as the location of its associated blob(s) in the current frame. The tracker's location can be further used to update the tracker's motion model and predict its location in the next frame. Further, in some cases, there may be trackers that are temporarily lost (e.g., when a blob the tracker was tracking is no longer detected), in which case the locations of such trackers also need to be predicted (e.g., by a Kalman filter). Such trackers are temporarily not shown to the system. Prediction of the bounding box location helps not only to maintain certain level of tracking for lost and/or merged bounding boxes, but also to give more accurate estimation of the initial position of the trackers so that the association of the bounding boxes and trackers can be made more precise.

As noted above, the location of a blob tracker in a current frame may be predicted based on information from a previous frame. One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) (e.g., the blob(s) bounding box(es)) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified as its predicted location from the previous frame, meaning that the motion model for the blob tracker is not corrected and the prediction propagates with the blob tracker's last model (from the previous frame).

Other than the location of a tracker, the state or status of a tracker can also, or alternatively, include a tracker's temporal status. The temporal status can include whether the tracker is a new tracker that was not present before the current frame, whether the tracker has been alive for certain frames, or other suitable temporal status. Other states can include, additionally or alternatively, whether the tracker is considered as lost when it does not associate with any foreground blob in the current frame, whether the tracker is considered as a dead tracker if it fails to associate with any blobs for a certain number of consecutive frames (e.g., two or more), or other suitable tracker states.

There may be other status information needed for updating the tracker, which may require a state machine for object tracking. Given the information of the associated blob(s) and the tracker's own status history table, the status also needs to be updated. The state machine collects all the necessary information and updates the status accordingly. Various statuses can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

Regardless of the tracking method being used, a new tracker starts to be associated with a blob in one frame and, moving forward, the new tracker may be connected with possibly moving blobs across multiple frames. When a tracker has been continuously associated with blobs and a duration (a threshold duration) has passed, the tracker may be promoted to be a normal tracker. A normal tracker is output as an identified tracker-blob pair. For example, a tracker-blob pair is output at the system level as an event (e.g., presented as a tracked object on a display, output as an alert, and/or other suitable event) when the tracker is promoted to be a normal tracker. In some implementations, a normal tracker (e.g., including certain status data of the normal tracker, the motion model for the normal tracker, or other information related to the normal tracker) can be output as part of object metadata. The metadata, including the normal tracker, can be output from the video analytics system (e.g., an IP camera running the video analytics system) to a server or other system storage. The metadata can then be analyzed for event detection (e.g., by rule interpreter). A tracker that is not promoted as a normal tracker can be removed (or killed), after which the tracker can be considered as dead.

As noted above, blob trackers can have various temporal states, such as a new state for a tracker of a current frame that was not present before the current frame, a lost state for a tracker that is not associated or matched with any foreground blob in the current frame, a dead state for a tracker that fails to associate with any blobs for a certain number of consecutive frames (e.g., 2 or more frames, a threshold duration, or the like), a normal state for a tracker that is to be output as an identified tracker-blob pair to the video analytics system, or other suitable tracker states. Another temporal state that can be maintained for a blob tracker is a duration of the tracker. The duration of a blob tracker includes the number of frames (or other temporal measurement, such as time) the tracker has been associated with one or more blobs.

As previously described, a blob tracker can be promoted or converted to be a normal tracker when certain conditions are met. A tracker is given a new state when the tracker is created and its duration of being associated with any blobs is 0. The duration of the blob tracker can be monitored, as well as its temporal state (new, lost, hidden, or the like). As long as the current state is not hidden or lost, and as long as the duration is less than a threshold duration T1, the state of the new tracker is kept as a new state. A hidden tracker may refer to a tracker that was previously normal (thus independent), but later merged into another tracker C. In order to enable this hidden tracker to be identified later due to the anticipation that the merged object may be split later, it is still kept as associated with the other tracker C which is containing it.

The threshold duration T1 is a duration that a new blob tracker must be continuously associated with one or more blobs before it is converted to a normal tracker (transitioned to a normal state). The threshold duration can be a number of frames (e.g., at least N frames) or an amount of time. In one illustrative example, a blob tracker can be in a new state for 30 frames (corresponding to one second in systems that operate using 30 frames per second), or any other suitable number of frames or amount of time, before being converted to a normal tracker. If the blob tracker has been continuously associated with blobs for the threshold duration (duration≥T1), the blob tracker is converted to a normal tracker by being transitioned from a new status to a normal status.

If, during the threshold duration T1, the new tracker becomes hidden or lost (e.g., not associated or matched with any foreground blob), the state of the tracker can be transitioned from new to dead, and the blob tracker can be removed from blob trackers maintained for a video sequence (e.g., removed from a buffer that stores the trackers for the video sequence).

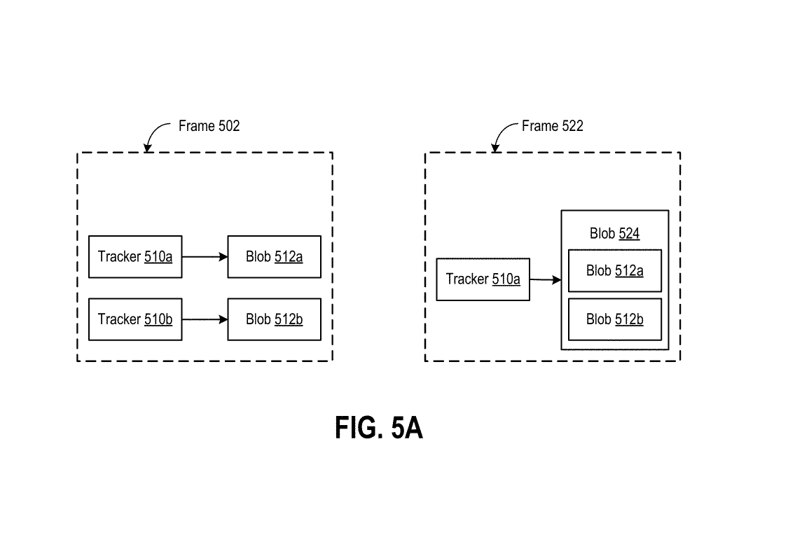

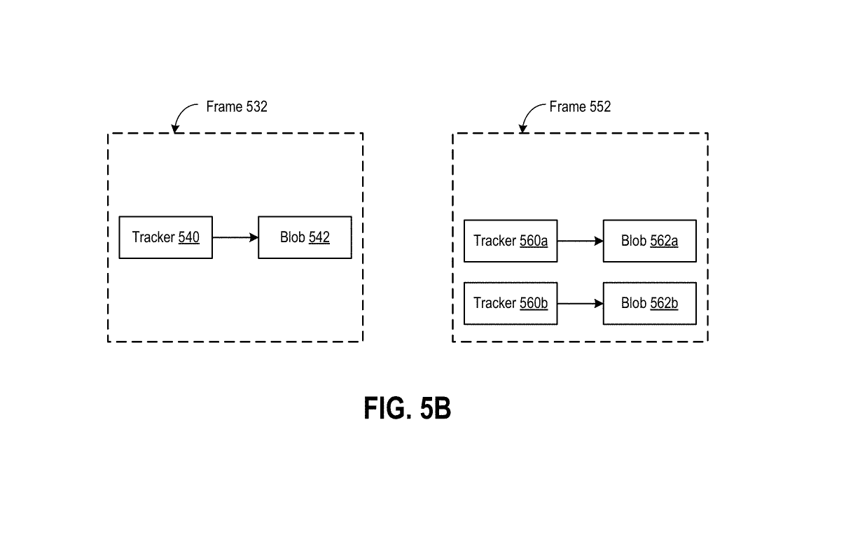

In some examples, objects may intersect or group together, in which case the blob detection system can detect one blob (a merged blob) that contains more than one object of interest (e.g., multiple objects that are being tracked). For example, as a person walks near another person in a scene, the bounding boxes for the two persons can become a merged bounding box (corresponding to a merged blob). The merged bounding box can be tracked with a single blob tracker (referred to as a container tracker), which can include one of the blob trackers that was associated with one of the blobs making up the merged blob, with the other blob(s)' trackers being referred to as merge-contained trackers. For example, a merge-contained tracker is a tracker (new or normal) that was merged with another tracker when two blobs for the respective trackers are merged, and thus became hidden and carried by the container tracker. FIG. 5A illustrates an example of the merging of an object tracker between two frames. For example, in frame 502, trackers 510a and 510b are associated with, respectively, blobs 512a and 512b. In frame 522, tracker 510b becomes hidden, and tracker 510a is associated with a merged blob 524 formed by the merging of blobs 512a and 512b. If the merging occurs during the threshold duration T1, tracker 510a may also be associated with the new status, or any other status that indicates that tracker 510a is not a normal tracker.

A tracker that is split from an existing tracker is referred to as a split-new tracker. The tracker from which the split-new tracker is split is referred to as a parent tracker or a split-from tracker. In some examples, a split-new tracker can result when an object is detected as multiple separate blobs, in which case the multiple blobs are associated (or matching or mapping) to one active tracker. For instance, one active tracker can only be mapped to one blob. All the other blobs (the blobs remaining from the multiple blobs that are not mapped to the tracker) cannot be mapped to any existing trackers. In such examples, new trackers will be created for the other blobs, and these new trackers are assigned the state “split-new.” Such a split-new tracker can be referred to as the child tracker of the original tracker its associated blob is mapped to. The corresponding original tracker can be referred to as the parent tracker (or the split-from tracker) of the child tracker. In some examples, a split-new tracker can also result from a merge-contained tracker. As noted above, a merge-contained tracker is a tracker that was merged with another tracker (when two blobs for the respective trackers are merged) and thus became hidden and carried by the container tracker. A merge-contained tracker can be split from the container tracker if the container tracker is active and the container tracker has a mapped blob in the current frame.

FIG. 5B illustrates an example of the splitting of an object tracker between two frames. For example, in frame 532, tracker 540 is associated with blob 542. In frame 552, tracker 540 is split into child trackers 560a and 560b associated with, respectively, blobs 562a and 562b. Tracker 540 may be associated with the dead or lost status, whereas child trackers 560a and 560b may be associated with the “split-new” status. The statuses of child trackers 560a and 560b may transition to the normal status if the trackers are associated with blobs 562a and 562b continuously through the threshold duration T1, as discussed above.

Video analytics systems that use motion-based object/blob detection and tracking mainly track moving objects detected as a set of blobs. Each blob does not necessarily correspond to an object. In addition, each blob may not necessarily correspond to a truly moving object. Since the motion detection is performed using background subtraction, the complexity of the solution is not proportional to the number of moving objects in the scene. However, a benefit of video analytics systems that rely on motion-based object/blob detection is that such systems can be performed by relatively low power devices (e.g., less powerful IP camera (IPC) devices). For example, such a video analytics solution could be implemented in a low complexity arm-based chip set, such as the Qualcomm Snapdragon™ 625 (SD625 or the APQ8053 chip). Such a solution could even offer real-time performance (e.g., 30 fps) utilizing only 1 CPU core.

To improve the accuracy of tracking an object, a complex object detector system can also be employed in combination with the aforementioned motion-based object/blob detection system to perform the tracking of an object. The complex object detector system can employ a feature-based scheme to detect or classify objects based on visual features of the objects, and generate a set of detector bounding boxes associated with the classified/detected objects. Various deep learning-based detectors can be used to detect or classify objects in video frames. For example, single shot detector (SSD) is a fast single-shot object detector that can be applied for multiple object categories. A feature of the SSD model is the use of multi-scale convolutional bounding box outputs attached to multiple feature maps at the top of the neural network. SSD can match objects with default boxes of different aspect ratios. Each element of the feature map has a number of default boxes associated with it. Any default box with an intersection-over-union with a ground truth box over a threshold (e.g., 0.4, 0.5, 0.6, or other suitable threshold) can be considered a match for the object. The neural network can also output a probability vector representing the probabilities of the box containing an object of a particular class.

Another deep learning-based detector that can be used to detect or classify objects in video frames includes the You only look once (YOLO) detector, which is an alternative to the SSD object detection system. A YOLO network can divide the image into regions and predicts bounding boxes and probabilities for each region. These bounding boxes are weighted by the predicted probabilities. A confidence score can be provided to indicate how certain it is that the predicted bounding box actually encloses an object.

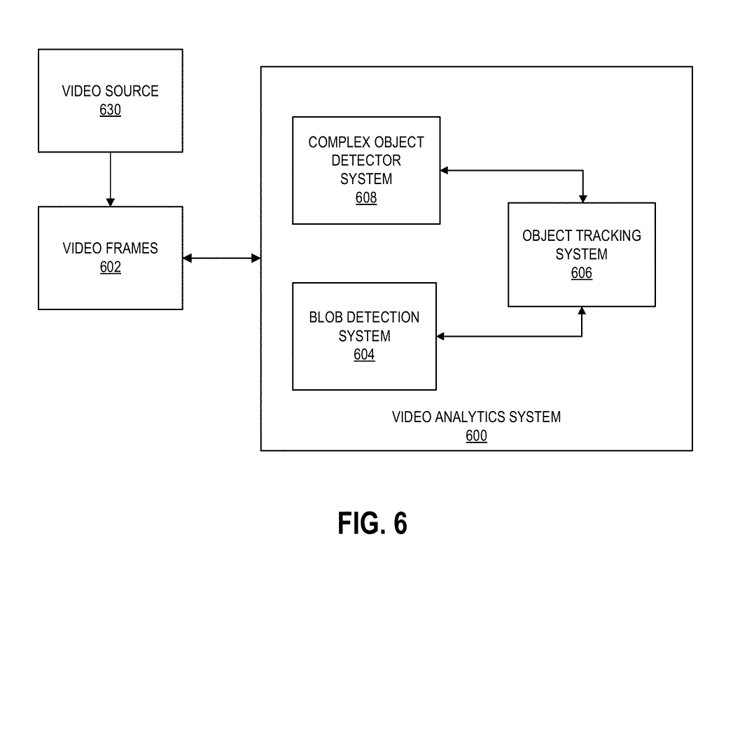

FIG. 6 is an example of a hybrid video analytics system 600 that can be used to perform object detection and tracking in real-time using deep learning. The hybrid video analytics system 600 combines, for example, blob detection and complex object detection using a deep learning-based system to detect and track objects in images with high accuracy and in real-time. As used herein, the term “real-time” refers to detecting and tracking objects in a video sequence as the video sequence is being captured. The video analytics system 600 includes a blob detection system 604, an object tracking system 606, and a complex object detector system 608. The blob detection system 604 is similar to and can perform the same operations as the blob detection system 604 described above with respect to FIG. 1-FIG. 4. For example, the blob detection system 604 can receive video frames 602 of a video sequence provided by a video source 630. The blob detection system 604 can perform object detection to detect one or more blobs (representing one or more objects) for the video frames 602. Blob bounding boxes associated with the blobs are generated by the blob detection system 604. The blobs and/or the blob bounding boxes can be output for further processing by the video analytics system 600. While examples are described herein using bounding boxes as examples of bounding regions, one of ordinary skill will appreciate that any other suitable bounding region could be used instead of bounding boxes, such as bounding circles, bounding ellipses, or any other suitably-shaped regions representing trackers, blobs, and/or objects.

Complex object detector system 608 can apply one or more deep learning networks to one or more of the frames 602 of the received video sequence to locate and classify objects in the one or more frames. An output of the deep learning system 1208 can include a set of detector bounding boxes representing the detected and classified objects. Examples of deep learning networks that can be applied by the deep learning system 1208 can include an SSD detector, a YOLO detector, or any other suitable neural network.

A final set of bounding boxes are determined using detector bounding boxes produced by complex object detector system 608 and blob bounding boxes produced by the blob detection system 604. For example, the blob bounding boxes (generated by the blob detection system 604) and the detector bounding boxes (generated by the deep learning system 1208) can be generated for a same video frame, and can be analyzed to determine a final set of bounding boxes for the video frame. A status can also be determined for each of the bounding boxes, and the associated object tracker, in the final set of bounding boxes. For example, as discussed above with respect to FIG. 5A and FIG. 5B, the bounding box for a newly created tracker (e.g., due to detection of a new object, splitting of trackers, merging of trackers, etc.) may be associated with the new status. On the other hand, a tracker that has been associated with a blob for a threshold duration T1 may be associated with the normal status.

The final set of bounding boxes determined for a video frame (representing blobs in the video frame) can be provided, for example, for blob processing, object tracking, and other video analytics functions. For example, final bounding boxes can be provided to the object tracking system 606, which can perform object tracking to track the detected blobs and the objects represented by the blobs. The object tracking system 606 is similar to and can perform the same operations as the object tracking system 106 described above with respect to FIG. 1-FIG. 4. As described above, the object tracking system 606 can associate trackers and their bounding boxes with the one or more blobs (using the blob bounding boxes) detected by the blob detection system 604. A tracker bounding box can then be displayed as tracking a tracked object/blob when certain conditions are met (e.g., the blob has been tracked for a certain number of frames, a certain period of time, and/or other suitable conditions).

In some cases, the video analytics system 600 can perform object detection and tracking at every video frame of the received video sequence to detect and track objects in the frames (using the techniques described above with respect to FIG. 1-FIG. 4). In some implementations, object detection and tracking may not be performed for every video frame of the video sequence. For example, object detection and tracking may be performed for every other video frame or for some other suitable number of video frames.

In some cases, complex object detector system 608 can apply a deep learning network to only a subset of frames of the received video sequence. For example, the deep learning system 1208 can apply the deep learning network every N frames, with N being determined based on the delay required to process a frame using the deep learning network and the frame rate of the video sequence. Each frame for which both blob detection and a deep learning network is applied is referred to herein as a key frame. For other frames (referred to as non-key frames), blob detection is applied without also applying the deep learning network.

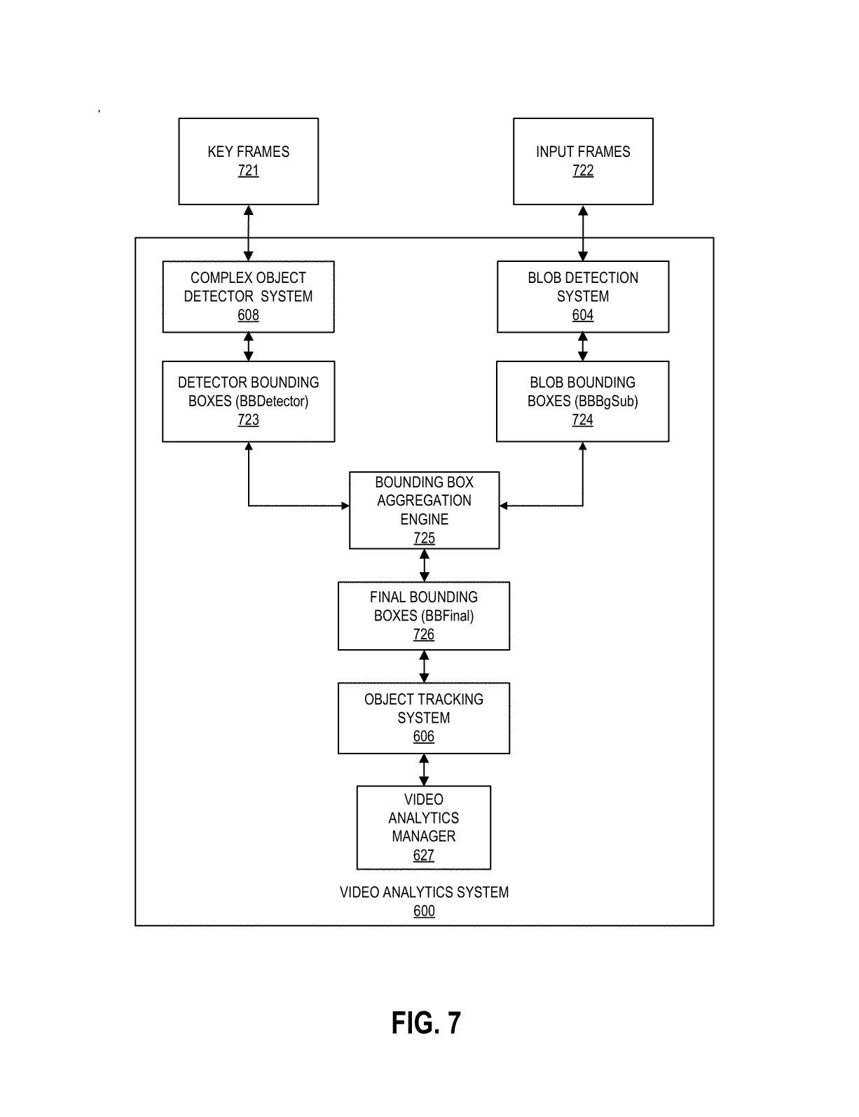

FIG. 7 is a diagram illustrating a more detailed example of the video analytics system 600. As previously noted, the video analytics system 600 includes complex object detector system 608 that implements a high complexity detector (e.g., based on deep learning based object detection) as part of a motion-based video analytics system (e.g., based on the detection and tracking of motion blobs, such as, for example, through background subtraction). The high complexity detector is applied by complex object detector 608 at a much lower frequency than motion-based blob detection is applied by the blob detection system 604. For example, as shown in FIG. 7, the input to complex object detector system 608 is every key frame 721 of a video sequence, and the input to the blob detection system is every input frame 722 of the video sequence. A key frame 721 occurs every N frames, with N being an integer value determined based on the delay required to process a frame using the deep learning network and the frame rate of the video sequence. For example, the processing time for the complex object detector 608 to apply the deep learning network to a frame is denoted as T_{d}, and assuming the system frame rate is fr, the high complexity detector is applied once every N=ceil(T_{d}*fr) frames.

The complex object detector 608 applies the deep learning based detector to the key frames 721. For example, at each key frame, the deep learning system 1208 applies a deep learning network to detect and classify objects in the frame, and to output detector bounding boxes 723 for each of the classified objects. In some cases, a list of detector bounding boxes (denoted as BBDetector) can be generated and output by the complex object detector 608. In one illustrative example, the complex object detector 608 can apply an SSD detector to a key frame to detect objects in the key frame and to output bounding boxes for the objects detected in the key frame. A YOLO detector or other suitable deep neural network-based detector can be applied (as an alternative to, or in addition to, an SSD detector) by complex object detector 608 to detect objects and output bounding boxes for key frames. In some cases, the complex object detector 608 can apply another machine learning-based technique other than a deep neural network.

The deep network applied by complex object detector 608 can also generate and output classifications and confidence levels (also referred to as confidence values or confidence scores) for each object detected in a key frame. A classification and confidence level determined for an object can be associated with the bounding box determined for the object. For instance, the deep learning network applied by complex object detector 608 may provide detector bounding boxes 723 for a key frame, along with a category classification and a confidence level (CL) associated with each detector bounding box. The object classification indicates a category determined for an object detected in a key frame using the deep learning classification network, where the confidence level for an object indicates a likelihood (e.g., as a probability or other suitable representation of likelihood) that the object is of a particular category.

Blob detection system 604 applies blob detection to the input video frames 722. Blob detection system 604 is similar to and can perform the same operations as blob detection system 104 described above with respect to FIG. 1-FIG. 4. As noted previously, blob detection can be performed at every input video frame 722 of the received video sequence to detect blobs in the frames. In some cases, blob detection can be performed for every other video frame or for some other suitable number of video frames. For an input frame currently being processed by the blob detection system 604 (referred to herein as a current frame or current video frame), blob bounding boxes 724 (representing detected blobs) are generated for blobs detected using the motion-based object detection techniques described above with respect to FIG. 1-FIG. 4. In some cases, a list of blob bounding boxes (denoted as BBBgSub) can be generated and output from the blob detection system 604.

For key frames, the list of blob bounding boxes 724 generated by blob detection system 604 and the list of detector bounding boxes 723 generated by complex object detector 608 are output to the bounding box aggregation engine 725. The bounding box aggregation engine 725 can aggregate the two lists of blobs (BBDetector and BBBgSub) to produce a final set of bounding boxes 726 for a current key frame, or to provide the list of blob bounding boxes 724 (BBBgSub) as the final set of bounding boxes 726 for a current non-key frame. The final set of bounding boxes 726 is denoted as BBFinal in FIG. 7.

For the key frames, the bounding box aggregation engine 725 can analyze detector bounding boxes 723 and blob bounding boxes 724 to determine which bounding boxes to include in the final bounding boxes 726 and to determine a status for the bounding boxes (and the blobs represented by the bounding boxes). For example, the system 600 may pair a detector bounding box 723 with a blob bounding box 724 based on a degree of overlap between the two bounding boxes, and can include the detector bounding box 723 of the pair in the final set of bounding boxes 726 while excluding the blob bounding box 724 of the pair from the final set of bounding boxes 726. As another example, a detector bounding box 723 may be excluded from the final set of bounding boxes 726 if the confidence level of the detector bounding box is below a confidence threshold.

The set of final bounding boxes 726 can be output to object tracking system 606, which can then use the final bounding boxes 726 to perform object tracking. Object tracking can be performed using the techniques described above with respect to FIG. 1-FIG. 4. The set of final bounding boxes 726 can be used as the blob bounding boxes for a current frame when performing cost determination (by cost determination engine 412) and data association (by data association engine 414). For example, with the set of final bounding boxes 726 (BBFinal), object tracking system 606 can track the objects in a frame similarly as that described above and using multi-to-multi tracking, with the exception that some objects may be determined to be true positive or false positive objects in the current frame based on the results from the bounding box aggregation engine 725. Further details of multi-to-multi tracking techniques are described in U.S. application Ser. No. 15/384,911, filed Dec. 20, 2016, which is hereby incorporated by reference in its entirety, for all purposes.

Video analytics manager 627 can record object detection and tracking events based on information from the object tracking system 606. For example, a state machine ran by the object tracking system 606 can update the states (or statuses) of the various trackers, and can provide the states to video analytics manager 627. Video analytics manager 627 can maintain metadata for each of the trackers (and bounding boxes). Object tracking system 606 can also predict the tracker positions for a next frame based on the positions of the blob for which the trackers are associated, as described above with respect to FIG. 1-FIG. 4. In one illustrative example, the object tracking system 606 can implement a Kalman filter to predict the tracker positions.

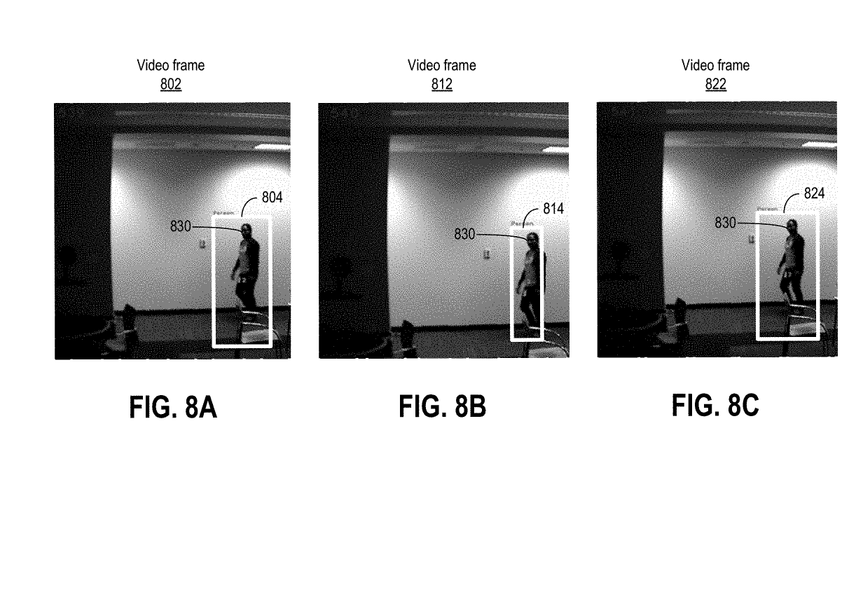

As discussed above, given that an output bounding box can be generated based on a detector bounding box for a key frame and based on a blob bounding box for a non-key frame, the smoothness of the output bounding box may degrade across a set of neighboring key frame and non-frame. FIG. 8A-FIG. 8C are video frames illustrating an example of the degradation in the smoothness of an output bounding box. FIG. 8A illustrates a video frame 802 including an output bounding box 804. FIG. 8B illustrates a video frame 812 including an output bounding box 814. FIG. 8C illustrates a video frame 822 including an output bounding box 824. Video frames 802, 812, and 822 are a set of continuous video frames. Video frame 812 may be a key frame, in which case the output bounding box 814 can be a detector bounding box generated by, for example, complex object detector 608. Video frames 802 and 822 may be non-key frames, in which case the output bounding boxes 804 and 824 can be generated by the blob detection system 604. Output bounding boxes 804, 814, and 824 are associated with the same object 830, which is a person in this example. As can be seen, the output bounding boxes 804, 814, and 824 change sizes and locations from one frame to another due to the different types of detections (deep learning based detection and background subtraction based detection) being performed for the different video frames 802, 812, 822.

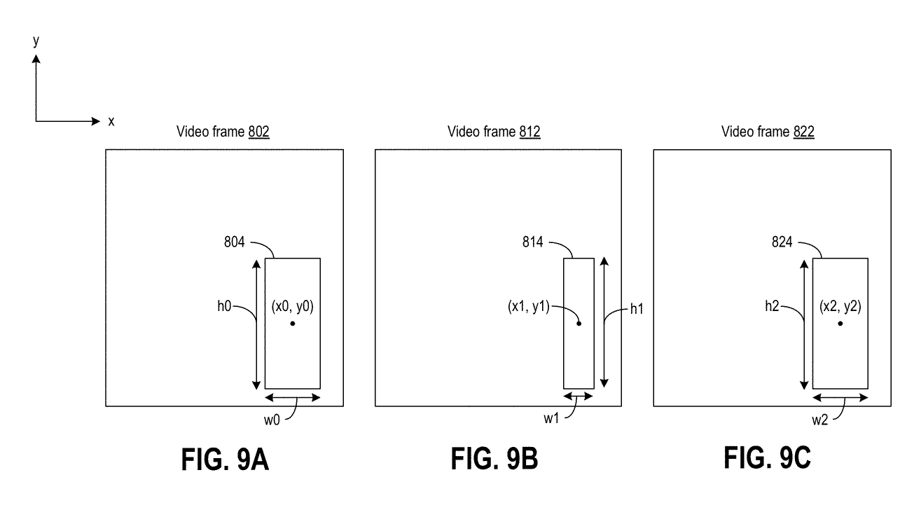

FIG. 9A-FIG. 9C provide a simplified illustration of output bounding boxes 804, 814, and 824 in, respectively, video frames 802, 812, and 822. As shown in FIG. 9A, output bounding box 804 has a height of h0 and a width of w0. The center location of output bounding box 804 is at the pixel coordinates of (x0, y0) within video frame 802, with x0 representing the pixel coordinate of the center location of output bounding box 804 along a horizontal direction, and y0 representing the pixel coordinate of the center location of output bounding box 804 along a vertical direction. Moreover, output bounding box 814 has a height of h1 and a width of w1, and the center location of output bounding box 814 is at the pixel coordinates of (x1, y1) within video frame 812. Further, output bounding box 824 has a height of h2 and a width of w2, and the center location of output bounding box 824 is at the pixel coordinates of (x2, y2) within video frame 822.

As discussed above, the smoothness of an output bounding box can refer to a rate of change in one or more attributes of the output bounding box over a set of continuous frames. Here, the smoothness of an output bounding box between video frames 802 or 812, or between video frames 812 and 822, can be determined based on a change in, for example, the width, the height, and/or the center location of the output bounding box. For example, the smoothness of an output bounding box across video frames 802 and 812 (e.g., represented by output bounding boxes 804 and 814) can be determined based on, for example, a width difference between widths w0 and w1, a height difference between heights h0 and h1, a horizontal distance between pixel coordinates x0 and x1, a vertical distance between pixel coordinates y0 and y1, or any combination thereof. Moreover, the smoothness of an output bounding box across video frames 812 and 822 (e.g., represented by output bounding boxes 814 and 824) can be determined based on, for example, a width difference between widths w0 and w1, a height difference between heights h0 and h1, a horizontal distance between pixel coordinates x0 and x1, a vertical distance between pixel coordinates y0 and y1, or any combination thereof.

As shown in FIG. 9A-9C, the output bounding box experiences a change in the width across video frames 802, 812, and 822, even though the output bounding box is associated with the same object 830. The change in the width can lead to errors in the tracking of object 830. For example, the width difference between widths w0 and w1 may incorrectly indicate that the object 830 has decreased in size, and the width difference between widths w1 and w2 may indicate that object 830 incorrectly expands in size, when in fact object 830 does not experience any shrinking or expansion as illustrated in video frames 802, 812, and 822. The change in the widths also creates the visual appearance of shrinking and/or expansion of the output bounding box when displayed, which can impede the visual tracking of object 830.

Moreover, as shown in FIG. 9A-9C, the output bounding box in each of the frames 802, 812, and 822 also experiences a change in the center locations, which can introduce further errors in the tracking of object 830. For example, between video frames 802 and 812, the system may determine, based on the center locations, that the output bounding box moves over a horizontal distance between x0 and x1, and over a vertical distance between y0 and y1. Also, between video frames 812 and 822, the system may determine that the output bounding box moves over a horizontal distance between x1 and x2, and over a vertical distance between y1 and y2. As shown in FIG. 9A-9C, the change in the width of the output bounding box also contributes to the change in the center location. Therefore, distances between the center locations of the bounding boxes (along the horizontal and/or vertical directions) may not correspond to the actual movement of object 830. A system that relies on the changes in the center locations of the output bounding boxes to track the motion of object 830 may, for example, overestimate the speed of motion, determine the wrong direction for the motion, and/or otherwise introduce errors in the tracking of object 830.

To improve the smoothness of the output bounding box, certain post-processing of the output bounding box can be performed before the output bounding box is used for object tracking. The post-processing may comprise, for example, predicting a target location of the output bounding box in a current frame, a target dimension of the output bounding box in the current frame, or other attributes of the output bounding box, based on a history of the output bounding box in previous frames. The attributes of the output bounding box can be set based on the predicted target location and/or target dimension, before the output bounding box is provided for object tracking in the current frame. By post-processing the output bounding box based on the history of the output bounding box in previous frames, the changes in the location and/or dimensions of the output bounding box can become more aligned with the historical average, which can improve the smoothness (and reduce a degree of jitter) of the output bounding box across a set of video frames.

Although post-processing the output bounding box based on a history of the output bounding box in previous frames can improve the smoothness, the post-processing can also introduce errors in the object tracking, especially when the video frames capture the images of an event. Such an event may include, for example, a new object appearing in a video frame (which can lead to creation of a new bounding box), objects overlapping as they move towards each other (which can lead to merging of bounding boxes and/or a sudden enlargement of a bounding box), a sudden acceleration of an object, etc. All of these events can lead to a rapid change in the location and/or the dimension of the output bounding box across a set of video frames, and a degradation in the smoothness of the output bounding box. However, the output bounding box should not be post-processed for these events, so that the location and/or dimension of the output bounding box can change correspondingly to these events. Performing post-processing on the output bounding box in these cases can prevent the system from tracking these events, which can lead to errors in the object tracking.

A bounding box smoothing system is described herein that can be employed to perform selectively post-processing of a bounding box to improve the degree of smoothness of the bounding box across a set of video frames, before the bounding box is provided for tracking an object. The system may obtain a set of input attributes of a candidate bounding box that is generated based on, for example, a detector bounding box, a blob bounding box, or a combination of both, within a current video frame. The input attributes may include, for example, a location of the candidate bounding box in the current video frame (e.g., represented by pixel coordinates), a size of the candidate bounding box (e.g., a width, a height, and/or other dimension information), or other attributes. The system may post-process the input attributes to performing smoothing, and generate output attributes of a current output bounding box based on a result of the post-processing. The system may also generate the output attributes of the current output bounding box as a copy of the input attributes of the candidate bounding box. The system can then provide the input attributes of the current output bounding box for tracking of the object.

The system may determine whether to post-process the input attributes based on a set of metrics that indicates a rate of change in a physical attribute of the object being tracked. The set of metrics may include, for example, a recent status of the object tracker (and the associated bounding box) in a most recent previous frame, a history of the status of the object tracker in a set of previous frames, a change in size of a bounding box associated with the object tracker, a change in the location of the bounding box associated with the object tracker, any combination thereof, and/or other suitable metrics. The set of metrics may indicate, for example, whether a new bounding box has been generated for the object (which may indicate a new appearance of the object in the video frames, a splitting of bounding boxes due to a movement of the object, or other events), and a duration (e.g., based on a number of consecutive frames) for which an output bounding box is associated with an object tracker. The set of metrics may also indicate, for example, a rate of movement of the object, a rate of change in a physical size of the object and/or a bounding box associated with the object (which may indicate a merging of the bounding boxes), and/or other changes in the physical attributes of the object.

The system may determine whether to perform post-processing of the input attributes of the candidate bounding box based on the set of metrics. For example, the system may determine not to perform the post-processing if, for example, the set of metrics indicates that the object tracker associated with the candidate bounding box is not currently assigned a normal status (e.g., due to a recent merging or splitting of bounding boxes, the object tracker is a new tracker with a newly created bounding box due to new appearance of the object, the object tracker is a lost tracker, or other events), or that the object tracker has not been in a normal status (and not associated with a particular output bounding box) continuously across a requisite number of previous frames. The system may also determine not to perform post-processing of the candidate bounding box if the candidate bounding box has undergone a rapid movement and/or a rapid change in size compared with a historical output bounding box of the same object tracker in previous frames. In all these cases, the system may determine that the object tracker is not yet in a stable state, and that the candidate bounding box should not be post-processed to allow the video analytics system to track the rapid changes. In some cases, the system may generate the output attributes of the current output bounding box as a copy of the input attributes of the candidate bounding box.

On the other hand, if the system determines that the object tracker is currently in a normal status and has been in the normal status for a requisite number of frames, and that the candidate bounding box has not undergone a rapid movement and/or a rapid change in size (compared with the historical output bounding box), the system may post-process the input attributes to perform smoothing, and may generate output attributes of a current output bounding box based on a result of the post-processing.

The post-processing may include updating one or more input attributes of the candidate bounding box, and setting the output attributes of the current output bounding box based on the updated one or more input attributes of the candidate bounding box. For example, the system can determine a location of the current output bounding box for the current frame based on an average distance of movements of the historical output bounding boxes (for the object tracker) across a pre-determined set of previous frames, and based on the distance of movement of the candidate bounding box in the current frame. As another example, the system may also determine a size (e.g., a width and/or a height) of the current output bounding box based on an average size (e.g., an average width and/or an average height) of the historical output bounding boxes across the pre-determined set of previous frames.

With embodiments of the present disclosure, post-processing can be selectively performed on a certain set of candidate bounding boxes to improve the smoothness of the output bounding box, while minimizing the likelihood that the post-processing prevents the system from tracking rapid events in the video frames. Such enhancements can improve the accuracy of object tracking by video analytics systems.

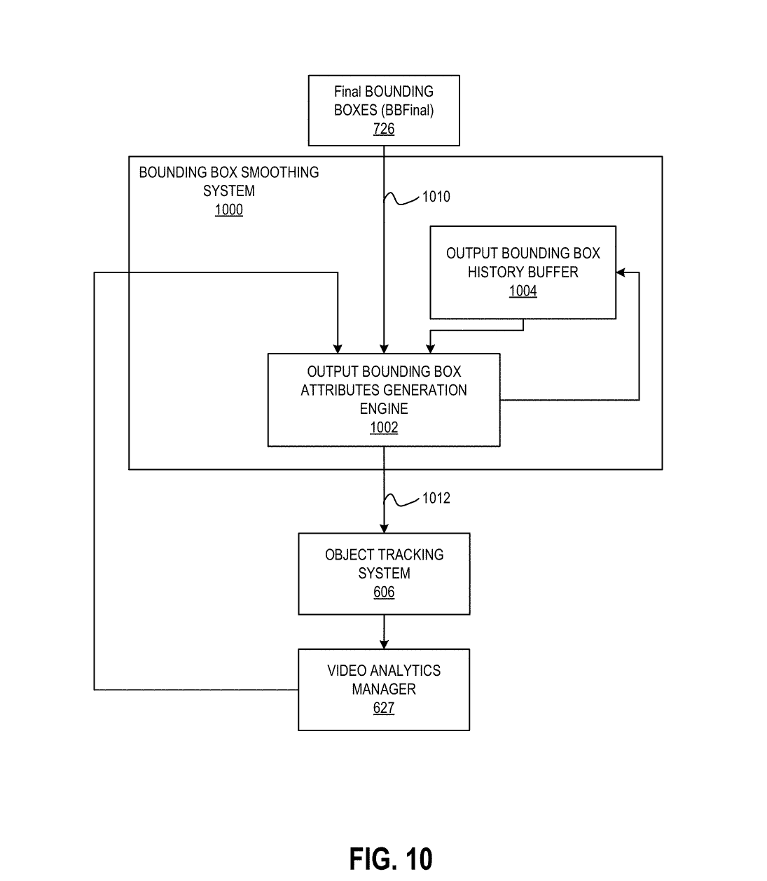

Reference is now made to FIG. 10, which illustrates an example of a bounding box smoothing system 1000. As shown in FIG. 10, bounding box smoothing system 1000 may include an output bounding box attributes generation engine 1002 and an output bounding box history buffer 1004. Bounding box smoothing system 1000 may be included in video analytics system 600 of FIG. 6 and can receive input attributes 1010 of a candidate bounding box. The candidate bounding box can be included in the final set of bounding boxes 726 generated for an object tracker in a current key frame or for a current non-key frame. Current attributes 1010 may include, for example, a location of the candidate bounding box within the current frame, a size (e.g., a width and a height) of the candidate bounding box, or other attributes.

Output bounding box attributes generation engine 1002 can output a set of output attributes 1012 of a current output bounding box for the object tracker in the current frame. The set of output attributes 1012 may include a location of the current output bounding box in the current frame, a size (e.g., a width and a height) of the current output bounding box, or other attributes. Output bounding box attributes generation engine 1002 can generate output attributes 1012 either as a copy of input attributes 1010, or based on a result of post-processing of the input attributes of the candidate bounding box. Output bounding box attributes generation engine 1002 can then provide output attributes 1012 representing the current output bounding box to object tracking system 606, which can perform tracking of the object based on output attributes 1012.

Output bounding box attributes generation engine 1002 can determine whether to generate output attributes 1012 as a copy of input attributes 1010, or to generate output attributes 1012 based on a result of post-processing of the input attributes 1010, based on a set of metrics. As discussed above, the set of metrics may include a recent status of the object tracker (and the associated bounding box). For example, if the object tracker is not in a normal state (e.g., the object tracker being associated with a merged bounding box or a plurality of split bounding boxes, the object tracker being associated with a newly created bounding box, the object tracker being associated with a lost bounding box, or does not have a normal state for other reasons) in the most recent previous frame, output bounding box attributes generation engine 1002 may determine to generate output attributes 1012 as a copy of input attributes 1010. Output bounding box attributes generation engine 1002 may receive the state or status information of the object tracker associated with the candidate bounding box from video analytics manager 627. For example, as discussed above, video analytics manager 627 can record object detection and tracking events based on information from the object tracking system 606. Video analytics manager 627 can maintain metadata for each of the object trackers (and bounding boxes), and can transmit the metadata to output bounding box attributes generation engine 1002. Based on the metadata, output bounding box attributes generation engine 1002 can determine a state or status of the object tracker associated with the candidate bounding box, and determine how to generate output attributes 1012 accordingly.

Output bounding box attributes generation engine 1002 can also determine whether to generate output attributes 1012 as a copy of input attributes 1010, or to generate output attributes 1012 based on a result of post-processing of the input attributes 1010, based on other information included in the set of metrics. For example, the set of metrics may include a rate of movement, a rate of change in size of the candidate bounding box (or other attributes) compared with a historical output bounding box of the same object tracker in previous frames, and may indicate whether the object being tracked has just undergone a rapid movement and/or a rapid change in size. Further, the set of metrics may also include a history of the status of the object tracker, and may indicate whether the object tracker has been in the normal state continuously across a requisite number of previous frames. If the set of metrics indicate that the candidate bounding box has undergone a rapid movement and/or rapid change in size, or that the object tracker has been in normal state only for a small number of frames, the output bounding box attributes generation engine 1002 can determine that the object tracker is not yet in a stable state, and can generate output attributes 1012 as a copy of input attributes 1010 without post-processing.

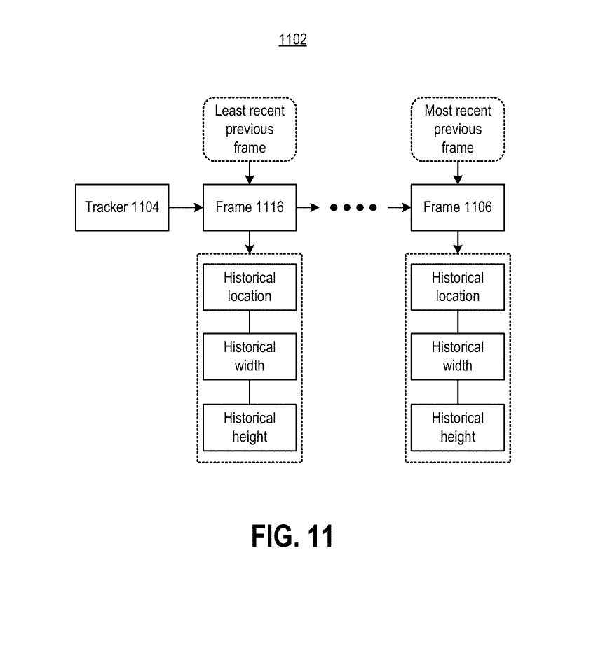

Output bounding box attributes generation engine 1002 can obtain the information of the historical output bounding box from the output bounding box history buffer 1004. Reference is now made to FIG. 11, which illustrates an example of internal components of the output bounding box history buffer 1004. As shown in FIG. 11, the output bounding box history buffer 1004 can include a buffer queue 1102 for an object tracker 1104. The buffer queue 1102 can store a history of attributes (e.g., a location, a width, a height, a combination thereof, and/or other attributes) of a historical output bounding box for an object tracker 1104 determined in a set of previous frames (including frames 1106 and 1116), which can be a most recent previous frame (e.g., a frame immediately before the current frame in a video sequence) and a least recent previous frame (e.g., a frame before the current frame and before the most recent previous frame in the video sequence). The output bounding box history buffer 1004 can receive the attributes of the current output bounding box from output bounding box attributes generation engine 1002 for storage as part of the history of attributes. The buffer queue 1102 can be configured to store the attributes for each of a pre-determined number of previous frames (e.g., four frames, five frames, eight frames, or any other number of frames). In some examples, the buffer queue 1102 can be configured as a first-in-first-out (FIFO) buffer, with the attributes of the most recent previous frame (e.g., frame 1106) being added at the end of the queue, and the attributes of a least recent previous frame (e.g., frame 1116) being removed from the head of the buffer queue to maintain the number of previous frames for which the history of attributes is stored in the buffer queue.

Moreover, output bounding box history buffer 1004 can also be configured to provide information about a history of the status of the object tracker. For example, output bounding box history buffer 1004 can be configured to store the attributes of an output bounding box as part of the history of attributes in buffer queue 1102 only if the object tracker associated with the output bounding box is in a normal state. Moreover, output bounding box history buffer 1004 can be configured to clear the history of attributes stored in the buffer queue 1102 whenever output bounding box history buffer 1004 detects that the object tracker is not in a normal state (e.g., based on an indication from output bounding box attributes generation engine 1002, based on the metadata provided by video analytics manager 627, or other suitable information). With such arrangements, output bounding box attributes generation engine 1002 can determine a number of previous frames across which the object tracker has been continuously in the normal state, and can determine how to generate output attributes 1012 accordingly. In some examples, output bounding box attributes generation engine 1002 may determine to generate output attributes 1012 as a copy of input attributes 1010 of the candidate bounding box if the buffer queue 1102 stores the history of attributes for fewer than the pre-determined number of previous frames (e.g., four frames, five frames, eight frames, or any other number of frames), based on an indication that that the object tracker has been continuously in the normal status for fewer than the pre-determined number of previous frames.

Moreover, output bounding box attributes generation engine 1002 can estimate a rate of change in the size of the candidate bounding box based on the historical attributes stored in buffer queue 1102, and can determine whether to post-process input attributes 1010 based on the rate of change of the size. For example, output bounding box attributes generation engine 1002 can estimate a rate of change in the width of the candidate bounding box by determining a width difference between the width of the candidate bounding box (as part of the input attributes) and the width of the historical output bounding box in the most recent previous frame (e.g., frame 1106) stored in the buffer queue 1102. Output bounding box attributes generation engine 1002 can also estimate a rate of change in the height of the candidate bounding box by determining a height difference between the height of the candidate bounding box (as part of the input attributes) and the height of the historical output bounding box in the most recent previous frame (e.g., frame 1106) stored in buffer queue 1102. The height and width differences can be used to estimate, respectively, a rate of change of the height and a rate of change of the width of the candidate bounding box within a time elapsed between the most recent previous frame and the current frame. Output bounding box attributes generation engine 1002 can compare the width difference against a width difference threshold, and the height difference against a height difference threshold. If the height difference exceeds the height difference threshold, and/or the width difference exceeds the width difference threshold, output bounding box attributes generation engine 1002 may determine that the candidate bounding box has undergone a rapid change in size, and that output attributes 1012 are to be generated as a copy of input attributes 1010 without post-processing. In some examples, both the height and width threshold can be set at 0.8.

Further, output bounding box attributes generation engine 1002 can also estimate a rate of movement of the candidate bounding box based on the historical attributes stored in buffer queue 1102. For example, output bounding box attributes generation engine 1002 can estimate a rate of movement of the candidate bounding box by determining a distance between the location of the candidate bounding box (as part of the input attributes) and the location of the historical output bounding box in the most recent previous frame (e.g., frame 1106) stored in buffer queue 1102. The distance can be used to estimate a rate of movement of the candidate bounding box within a time elapsed between the most recent previous frame and the current frame. In some examples, output bounding box attributes generation engine 1002 can determine a horizontal distance component (e.g., a component of the distance along a horizontal direction) and a vertical distance component (e.g., a component of the distance along a vertical direction), and compare each component against a distance threshold. If the horizontal distance component exceeds a first distance threshold, or the vertical distance component exceeds a second distance threshold, output bounding box attributes generation engine 1002 may determine that the candidate bounding box has undergone a rapid movement, and that output attributes 1012 are to be generated as a copy of input attributes 1010 without post-processing.

In some examples, the first distance threshold and the second distance threshold can be configured to provide an indication of a rapid movement of the object. For example, the first distance threshold and the second distance threshold can be set at a fixed value (e.g., 4, 6, 8, 10, or other suitable value), such that the comparison result can indicate a sudden change in the location of the candidate bounding box, which can also reflect a rapid movement of the object associated with the candidate bounding box.

In some examples, output bounding box attributes generation engine 1002 can also compare the aforementioned horizontal distance component and the vertical distance component against another set of thresholds determined based on an average rate of movement (per frame) of the historical output bounding box across the set of previous frames stored in buffer queue 1102. By comparing the rate of movement of the candidate box against the average rate of movement of historical output bounding, output bounding box attributes generation engine 1002 can also detect a sudden movement of the object that does not align with the historical average, even if the rate of movement is lower than the first and second threshold distances (e.g., 10) as described above. In some examples, output bounding box attributes generation engine 1002 can determine a third distance threshold and a fourth distance threshold based on an average rate of movement of the historical output bounding box, as follows:

$$\begin{matrix}{threshold}_{x} = \frac{{s}_{x} \times abs ( \begin{matrix}{x}_{most recent previous frame} - \\ {x}_{least recent previous frame}\end{matrix} )}{N} & ( Equation 2 ) \\ {threshold}_{y} = \frac{{s}_{y} \times abs ( \begin{matrix}{y}_{most recent previous frame} - \\ {y}_{least recent previous frame}\end{matrix} )}{N} & ( Equation 3 )\end{matrix}$$

Here, thresholdₓ corresponds to the third distance threshold (along the horizontal direction), whereas threshold_{y} corresponds to the fourth distance threshold (along the vertical direction). Also, x_{most recent previous frame} corresponds to the pixel x-coordinate of the center location of the most recent previous frame (e.g., frame 1106) stored in the buffer queue 1102, whereas x_{least recent previous frame} corresponds to the pixel x-coordinate of the center location of the least recent previous frame (e.g., frame 1116) stored in buffer queue 1102. Moreover, y_{most recent previous frame} corresponds to the pixel y-coordinate of the center location of the most recent previous frame (e.g., frame 1106) stored in buffer queue 1102, whereas y_{least recent previous frame} corresponds to the pixel y-coordinate of the center location of the least recent previous frame (e.g., frame 1116) stored in buffer queue 1102. Also, Sₓ and S_{y} can be pre-configured constants and can be set to, for example a value of 2 (or other value), in some examples. Further, N can be related to a number of frames separating between the most recent previous frame and the least recent previous frame (and including one of the most recent previous frame or the least recent previous frame) stored in buffer queue 1102. For example, if buffer queue 1102 stores the historical attributes of eight previous frames, N can be set to 7. Output bounding box attributes generation engine 1002 can compare the horizontal distance component (which represents a rate of movement of the candidate bounding box along a horizontal direction) against the third distance threshold, and compare the vertical distance component (which represents a rate of movement of the candidate bounding box along a vertical direction) against the fourth distance threshold. If the horizontal distance component exceeds the third distance threshold, or the vertical distance component exceeds the fourth distance threshold, output bounding box attributes generation engine 1002 may also determine that the candidate bounding box has undergone a rapid movement, and that output attributes 1012 are to be generated as a copy of input attributes 1010 without post-processing.

After determining, based on the set of metrics, to perform post-processing on input attributes 1010, output bounding box attributes generation engine 1002 can update input attributes 1010 of the candidate bounding box, and set output attributes 1012 of the current output bounding box based on the updated input attributes 1010, to perform the smoothing process. For example, output bounding box attributes generation engine 1002 can determine a location of the current output bounding box based on the location of the candidate bounding box and a predicted movement of the candidate bounding box, with the predicted movement being determined based on a weighted average between the rate of movement of the candidate bounding box and the average rate of movement of the historical output bounding box, as follows:

$$\begin{matrix} {hist\_mov}_{x} = \frac{\begin{matrix}{x}_{most recent previous frame} - \\ {x}_{least recent previous frame}\end{matrix}}{N} & ( Equation 4 ) \\ {current\_mov}_{x} = {x}_{current frame} - {x}_{most recent previous frame} & ( Equation 5 ) \\ {location}_{x} = {x}_{current frame} + {w}_{x} \times {hist\_mov}_{x} + ( 1 - {w}_{x} ) \times {current\_mov}_{x} & ( Equation 6 ) \\ {hist\_mov}_{y} = \frac{\begin{matrix}{y}_{most recent previous frame} - \\ {y}_{least recent previous frame}\end{matrix}}{N} \\ & ( Equation 7 ) \\ {current\_mov}_{y} = {y}_{current frame} - {y}_{most recent previous frame} & ( Equation 8 ) \\ {location}_{y} = {y}_{current frame} + {w}_{y} \times {hist\_mov}_{y} + ( 1 - {w}_{y} ) \times {current\_mov}_{y} & ( Equation 9 )\end{matrix}$$

Here, hist_movₓ corresponds to the average rate of movement (per frame) of the historical bounding box between the most recent previous frame (e.g., frame 1106) and the least recent previous frame (e.g., frame 1116) along a horizontal direction. Also, x_{most recent previous frame} corresponds to the pixel x-coordinate of the center location of the historical bounding box in the most recent previous frame (e.g., frame 1106), whereas x_{least recent previous frame} corresponds to the pixel x-coordinate of the center location of the historical bounding box in the least recent previous frame (e.g., frame 1116). N can be related to a number of frames separating between the most recent previous frame and the least recent previous frame (and including one of the most recent previous frame or the least recent previous frame) stored in buffer queue 1102. For example, if buffer queue 1102 stores the historical attributes of eight previous frames, N can be set to 7. Also, current_movₓ corresponds to the rate of movement (in one frame) of the candidate bounding box relative to the historical bounding box in the most recent previous frame (e.g., frame 1106) along the horizontal direction, whereas x_{current frame} corresponds to the pixel x-coordinate of the candidate bounding box in the current frame. Further, locationₓ corresponds to the pixel x-coordinate of the current output bounding box as part of output attributes 1012, and can be determined by adding a weighted average (based on weight wₓ) between current_movₓ and hist_movₓ to the pixel x-coordinate of the candidate bounding box. In some examples, weight wₓ can be set to 0.5 or other suitable value.

Moreover, hist_mov_{y} corresponds to the average rate of movement (per frame) of the historical bounding box between the most recent previous frame (e.g., frame 1106) and the least recent previous frame (e.g., frame 1116) along a vertical direction. Also, y_{most recent previous frame} corresponds to the pixel y-coordinate of the center location of the historical bounding box in the most recent previous frame (e.g., frame 1106), whereas y_{least recent previous frame} corresponds to the pixel y-coordinate of the center location of the historical bounding box in the least recent previous frame (e.g., frame 1116). In some examples, N can be set to 7 if buffer queue 1102 stores the historical attributes of eight previous frames, as described above. Also, current_mov_{y} corresponds to the rate of movement (in one frame) of the candidate bounding box relative to the historical bounding box in the most recent previous frame (e.g., frame 1106) along the vertical direction, whereas y_{current frame} corresponds to the pixel y-coordinate of the candidate bounding box in the current frame. Further, location_{y} corresponds to the pixel y-coordinate of the current output bounding box as part of output attributes 1012, and can be determined by adding a weighted average (based on weight w_{y}) between current_mov_{y} and hist_mov_{y} to the pixel y-coordinate of the candidate bounding box. In some examples, weight w_{y} can be set to 0.5, or can be set to a different value from wₓ.

Moreover, output bounding box attributes generation engine 1002 can also determine a size (e.g., a height and a width) of the current output bounding box based on the size (e.g., a height and a width) of the candidate bounding box and an average size of the historical bounding box across the set of previous frames stored in buffer queue 1102, as follows:

$$\begin{matrix}{width}_{hist} = \frac{{\sum }_{i = 1}^{M} {width}_{i}}{M} & ( Equation 10 ) \\ width = t \times {width}_{curr} + ( 1 - t ) \times {width}_{hist} & ( Equation 11 ) \\ {height}_{hist} = \frac{{\sum }_{i = 1}^{M} {height}_{i}}{M} & ( Equation 12 ) \\ height = u \times {height}_{curr} + ( 1 - u ) \times {height}_{hist} & ( Equation 13 )\end{matrix}$$

Here, widthₕᵢₛₜ and heightₕᵢₛₜ correspond to, respectively, the average width and the average height of the historical output bounding box across the set of previous frames stored in buffer queue 1102, whereas width_{c}, and height correspond to, respectively, the width and the height of the candidate bounding box (included in input attributes 1010). The value of widthₕᵢₛₜ can be determined by averaging the sum of widths of the historical output bounding box for each of the set of previous frames, with M representing the number of the set of previous frames (e.g., eight) for which the historical attributes are stored in buffer queue 1102. Further, the value of heightₕᵢₛₜ can be determined by averaging the sum of heights of the historical output bounding box for each of the set of previous frames, with M representing the number of the set of previous frames (e.g., eight) for which the historical attributes are stored in buffer queue 1102. Moreover, width corresponds to the width of the current output bounding box, and can be determined based on a weighted average (based on weight t) between widthₕᵢₛₜ and width_{curr}. Further, height corresponds to the height of the current output bounding box, and can be determined based on a weighted average (based on weight u) between heightₕᵢₛₜ and height_{curr}. In some examples, both weights t and u can be set to 0.3 or other suitable value.

Output bounding box attributes generation engine 1002 can then provide output attributes 1012 (either as a copy of input attributes 1010 or based on a result of the aforementioned post-processing of input attributes 1010) to object tracking system 606. Moreover, if the status of the object tracker remains in the normal state, output bounding box attributes generation engine 1002 also store output attributes 1012 at the end of buffer queue 1102 as the historical attributes for the most recent previous frame. Output bounding box attributes generation engine 1002 can then move on to process the candidate bounding box for the next frame.

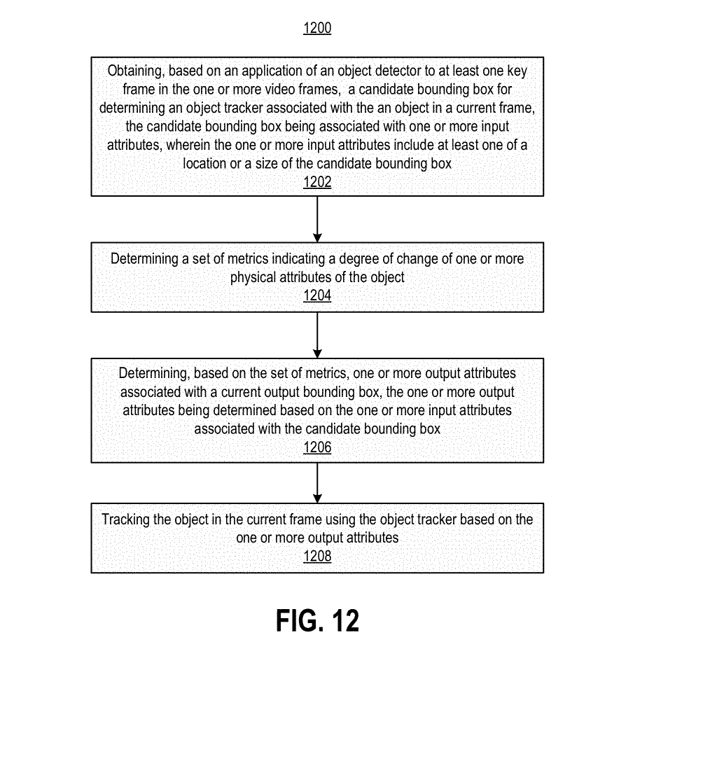

FIG. 12 is a flow chart illustrating an example of an object tracking process 1200 for one or more video frames using the techniques disclosed herein. At block 1202, process 1200 includes obtaining, based on an application of an object detector to at least one key frame in the one or more video frames, a candidate bounding box for an object tracker associated with an object in a current frame. The candidate bounding box is associated with one or more input attributes. The input attributes may include at least one of a location or a size of the candidate bounding box. A key frame can be a frame from the one or more video frames to which the object detector is applied. In some examples,the object detector may include a feature-based detector. In some examples, the object detector may include a complex object detector, and can be based on a trained classification network. A complex object detector may include, for example, an SSD detector, a YOLO detector, or other suitable complex detector, and can be part of complex object detector system 608 of FIG. 6. The first set of bounding regions may include detector bounding regions output by the complex object detector based on a result of classifying (or identify) and/or localizing certain object in one or more images.

At block 1204, process 1200 includes determining a set of metrics indicating a degree of change of one or more physical attributes of the object. In some cases, determining the set of metrics can include determining a status of the object tracker. For instance, the set of metrics may include, as illustrative examples, a recent status of the object tracker (and the associated bounding box) in a most recent previous frame, a history of the status of the object tracker in a set of previous frames, a change in size of a bounding box associated with the object tracker, a change in the location of the bounding box associated with the object tracker, or other suitable metrics. The set of metrics may indicate, for example, whether a new bounding box has been generated for the object (which may indicate a new appearance of the object in the video frames, a splitting of bounding boxes due to a movement of the object, or other events), and a duration (e.g., based on a number of consecutive frames) for which an output bounding box is associated with an object tracker. The set of metrics may also indicate, for example, a rate of movement of the object, a rate of change in a physical size of the object and/or a bounding box associated with the object (which may indicate a merging of the bounding boxes), or other changes in the physical attributes of the object.

At block 1206, process 1200 includes determining, based on the set of metrics, one or more output attributes associated with a current output bounding box. The one or more output attributes are determined based on the one or more input attributes associated with the candidate bounding box. In some examples, the one or more output attributes can be selected from the one or more input attributes associated with the candidate bounding box. For instance, the process 1200 may generate the one or more output attributes of the current output bounding box as a copy of the one or more input attributes of the candidate bounding box.

In some examples, as noted above, determining the set of metrics comprises determining a status of the object tracker. In such examples, determining the one or more output attributes associated with the current output bounding box can include determining whether the status of the object tracker satisfies a pre-determined condition selecting the one or more output attributes from the one or more input attributes associated with the candidate bounding box based on determining that a status of the object tracker does not satisfy the pre-determined condition. In some case, the status of the object tracker is a recent status of the object tracker in a most recent previous frame of the one or more video frames. The most recent previous frame is associated with a historical attribute for a historical output bounding box for the object tracker. In such cases, determining whether the status of the object tracker satisfies the pre-determined condition can include determining whether the object tracker has been continuously associated with the object for at least a threshold duration before the most recent previous frame.

In some cases, determining the one or more output attributes associated with the current output bounding box can further include, based on a determination that the object tracker has not been continuously associated with the object for at least the threshold duration before the most recent previous frame, selecting the one or more output attributes from the one or more input attributes associated with the candidate bounding box.

In some cases, the status of the object tracker can be an aggregate status of the object tracker across a set of previous frames of the one or more video frames, where each previous frame of the set of previous frames can be associated with a historical attribute for a historical output bounding box for the object. In such cases, determining whether the status of the object tracker satisfies the pre-determined condition can include determining whether the object tracker has been continuously associated with the object across at least a requisite number of previous frames of the set of previous frames. In some examples, determining the one or more output attributes associated with the current output bounding box can include, based on a determination that the object tracker has not been continuously associated with the object across the requisite number of previous frames, selecting the one or more output attributes from the one or more input attributes associated with the candidate bounding box.

In some examples, the process 1200 can include storing the one or more output attributes associated with the current output bounding box in a history buffer based on determining that the recent status of the object tracker in the most recent previous frame satisfies the pre-determined condition. In some examples, the process 1200 can include removing the historical attribute from a history buffer based on determining that the recent status of the object tracker in the most recent previous frame does not satisfy the pre-determined condition.

In some examples, determining the set of metrics can include determining a first historical width and a first historical height of a historical output bounding box for the object tracker in a most recent previous frame of the one or more video frames, and determining a current width and a current height of the candidate bounding box in the current frame. In such examples, the process 1200 can determine at least one of a width difference between the first historical width and the current width exceeds a width difference threshold, and/or that a height difference between the first historical height and the current height exceeds a height difference threshold. In such examples, determining the one or more output attributes associated with the current output bounding box can include selecting the one or more output attributes from the one or more input attributes associated with the candidate bounding box based on determining that the width difference between the first historical width and the current width exceeds the width difference threshold, and/or that the height difference between the first historical height and the current height exceeds the height difference threshold.

In some examples, determining the set of metrics can include determining a first historical location of a historical output bounding box for the object tracker in a most recent previous frame of the one or more video frames, and determining a current location of the candidate bounding box. In such examples, the process 1200 can determine that at least one of a first distance between the first historical location and the current location along a horizontal direction exceeds a first distance threshold, and/or a second distance between the first historical location and the current location along a vertical direction exceeds a second distance threshold. In such examples, determining the one or more output attributes associated with the current output bounding box can include selecting the one or more output attributes from the one or more input attributes associated with the candidate bounding box based on determining that the first distance between the first historical location and the current location along the horizontal direction exceeds the first distance threshold, and/or that the second distance between the first historical location and the current location along the vertical direction exceeds the second distance threshold.

In some examples, determining the set of metrics can include determining a first historical location of a historical output bounding box for the object tracker in a most recent previous frame of the one or more video frames, determining a second historical location of the historical output bounding box in a least recent previous frame of a pre-determined set of previous frames including the most recent previous frame, and determining a current location of the candidate bounding box. In some examples, determining the set of metrics can further include determining at least one of a third distance threshold based on averaging a third distance between the first historical location and the second historical location along a horizontal direction over a number of frames in the pre-determined set of previous frames, and/or a fourth distance threshold based on averaging a fourth distance between the first historical location and the second historical location along a vertical direction over the number of frames in the pre-determined set of previous frames. In such examples, the process 1200 can determine that at least one of a first distance between the first historical location and the current location along the horizontal direction exceeds the third distance threshold, and/or a second distance between the first historical location and the current location along the vertical direction exceeds the fourth distance threshold. In such examples, determining the one or more output attributes associated with the current output bounding box can include selecting the one or more output attributes from the one or more input attributes associated with the candidate bounding box based on determining that the first distance between the first historical location and the current location along the horizontal direction exceeds the third distance threshold, and/or that the second distance between the first historical location and the current location along the vertical direction exceeds the fourth distance threshold.

In some examples, the one or more output attributes can be selected from a result of post-processing of the one or more input attributes. The one or more output attributes associated with the current output bounding box may include at least one of an adjusted location or an adjusted size of the candidate bounding box when determined from the result of the post-processing of the one or more input attributes. The process 1200 may determine whether to perform post-processing of the input attributes of the candidate bounding box based on the set of metrics. For example, the process 1200 may determine not to perform the post-processing if, for example, the set of metrics indicates that the object tracker associated with the candidate bounding box is not currently in a normal state (e.g., due to a recent merging or splitting of bounding boxes, a newly created bounding box due to new appearance of the object, a lost tracker, or other events), or that the object tracker has not been in a normal state (and not associated with a particular output bounding box) continuously across a requisite number of previous frames. The process 1200 may also determine not to perform post-processing of the candidate bounding box if the candidate bounding box has undergone a rapid movement and/or a rapid change in size compared with a historical output bounding box of the same object tracker in previous frames. In such examples, the process 1200 may determine that the object tracker is not yet in a stable state, and that candidate bounding box should not be post-processed to allow the video analytics system to track the rapid changes. As noted above, in some examples, the one or more output attributes of the current output bounding box may be generated as a copy of the one or more input attributes of the candidate bounding box. On the other hand, in some cases, if the object tracker is currently in a normal state and has been in the normal status for a requisite number of frames, and the candidate bounding box does not undergo a rapid movement or a rapid change in size (compared with the compared with the historical output bounding box), the process 1200 can post-process the input attributes to perform smoothing, and can generate output attributes of a current output bounding box based on a result of the post-processing.

In some examples, the one or more output attributes can include a location of the current output bounding box. In such examples, selecting the one or more output attributes from the result of the post-processing the candidate bounding box can include determining a first historical location of a historical output bounding box for the object tracker in a most recent previous frame of the one or more video frames, determining a second historical location of the historical output bounding box in a least recent previous frame of a pre-determined set of previous frames including the most recent previous frame, determining a current location of the candidate bounding box, and determining the location of the current output bounding box based on the current location, the first historical location, and the second historical location.

In some examples, the one or more output attributes can include a width and a height of the current output bounding box. In such examples, selecting the one or more output attributes from the result of the post-processing the candidate bounding can include determining a current width and a current height of the candidate bounding box, determining an average historical width and an average historical height of a historical output bounding box for the object across a pre-determined set of previous frames, determining the width of the current output bounding box based on the current width and the average historical width, and determining the height of the current output bounding box based on the current height and the average historical height.

At block 1208, process 1200 comprises tracking the object in the current frame using the object tracker based on the one or more output attributes. For example, the tracking of the object can be based on the location and/or size of the output bounding box. The location and/or size of the output bounding box can be either identical to the location and/or size of the input candidate bounding box, or based on a result of post-processing at block 1206. In some examples, the process 1200 can include detecting a blob in the current frame using background subtraction. The blob includes pixels of at least a portion of the object in the current frame. In such examples, tracking the object in the current frame includes tracking the blob using the object tracker based on the one or more output attributes.

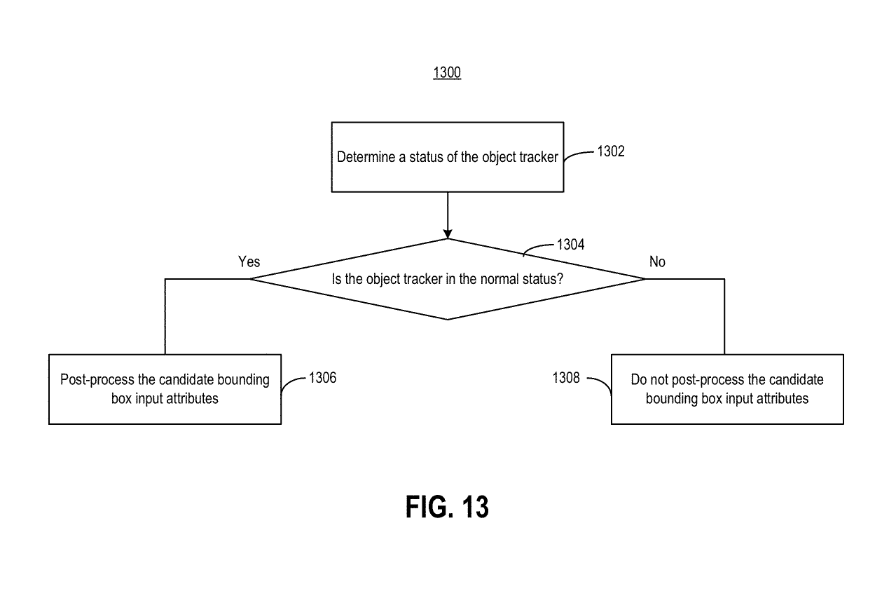

FIG. 13 is a flow chart illustrating an example of an object tracking process 1300 for one or more video frames using the techniques disclosed herein. Process 1300 can be part of block 1206 of FIG. 12 for determining whether to post-process the input attributes of candidate bounding box. Process 1300 includes, at block 1302, determining a status (or state) of the object tracker. The status of the object tracker can be obtained from, for example, a video analytics manager (e.g., video analytics manager 627), an object tracking system (e.g., object tracking system 606), etc. For example, the status can be determined based on metadata maintained by the video analytics manager.

If at block 1304, it is determined that the object tracker is not in a normal state or status (e.g., the object tracker is associated with a merged bounding box or a plurality of split bounding boxes, the object tracker is associated with a newly created bounding box, the object tracker is associated with a lost bounding box, or for other reasons) in the most recent previous frame, process 1300 may proceed to block 1306 and determine not to post-process the candidate bounding box attributes, to ensure that the candidate bounding box attributes are retained to reflect any potential new and sudden events. On the other hand, if the object tracker is in the normal state, process 1300 may proceed to block 1306 to post-process the candidate bounding box attributes to perform the smoothing process.

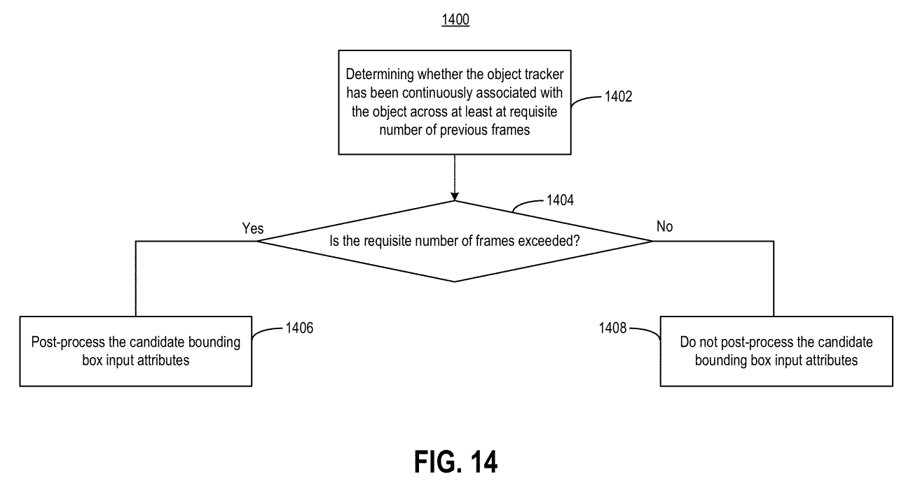

FIG. 14 is a flow chart illustrating an example of an object tracking process 1400 for one or more video frames using the techniques disclosed herein. Process 1400 can be part of block 1206 of FIG. 12 for determining whether to post-process the input attributes of candidate bounding box. Process 1400 includes, at block 1402, determining whether the object tracker has been continuously associated with the object across at least at requisite number of previous frames. The determination can be based on, for example, an output bounding box history buffer (e.g., output bounding box history buffer 1004) that stores a history of the status of the object tracker. For example, the output bounding box history buffer can be configured to clear the status history of an object tracker whenever the object tracker changes from a normal state to another state. Based on the status history stored in the output bounding box history buffer, it can be determined whether the object tracker has been continuously associated with the object across at least at requisite number of previous frames.

If at block 1404, it is determined that the object tracker has been continuously associated with the object across at least at requisite number of previous frames, process 1400 may proceed to block 1406 to post-process the candidate bounding box attributes to perform the smoothing process. If the object tracker has not been continuously associated with the object across at least at requisite number of previous frames, process 1400 may proceed to block 1408 and not to post-process the candidate bounding box attributes to perform the smoothing process.

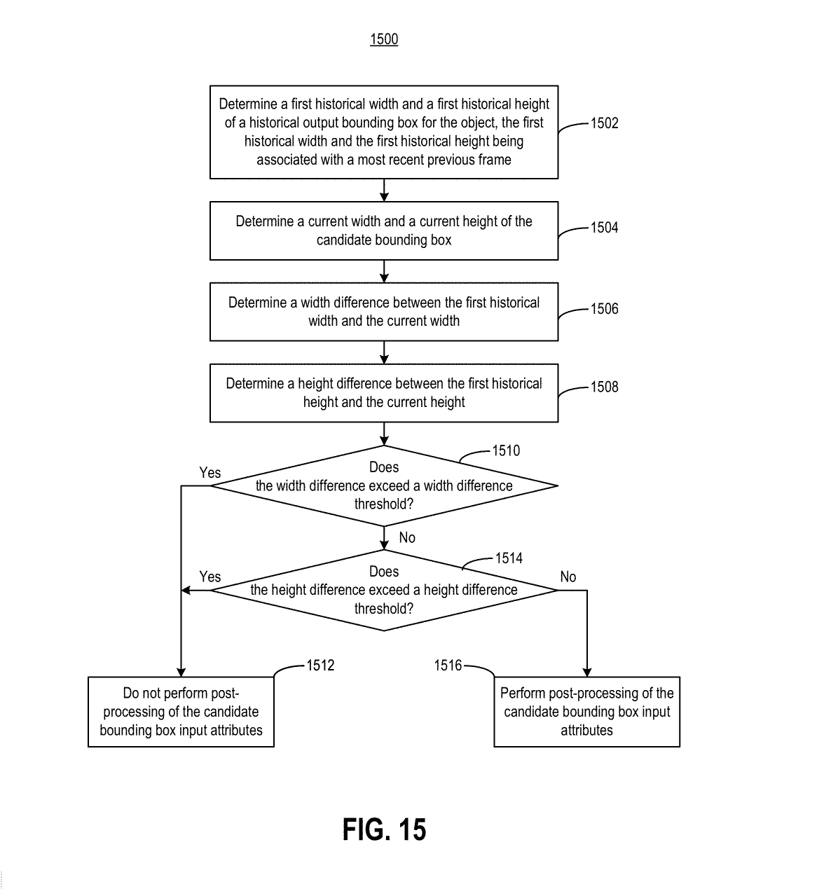

FIG. 15 is a flow chart illustrating an example of an object tracking process 1500 for one or more video frames using the techniques disclosed herein. Process 1500 can be part of block 1206 of FIG. 12 for determining whether to post-process the input attributes of candidate bounding box. Process 1500 includes, at block 1502, determining a first historical width and a first historical height of a historical output bounding box for the object, the first historical width and the first historical height being associated with a most recent previous frame. The first historical width and the first historical height information can be obtained from an output bounding box history buffer (e.g., output bounding box history buffer 1004) that stores historical attributes of the output bounding box for an object tracker. Process 1500 also includes, at block 1504, determining a current width and a current height of the candidate bounding box. The current width and the current height can be obtained from the input attributes of the candidate bounding box. Process 1500 further includes, at block 1506, determining a width difference between the first historical width and the current width, and at block 1508, determining a height difference between the first historical height and the current height.

Process 1500 then proceed to block 1510 to determine whether the width difference exceeds a width difference threshold. If the width difference exceeds the width difference threshold, process 1500 may proceed to block 1512 and determine not to perform post-processing of the candidate bounding box input attributes. If the width difference does not exceed the width difference threshold, process 1500 may proceed to block 1514 to determine whether the height difference exceeds a height difference threshold. If the height difference exceeds the height difference threshold, process 1500 may also proceed to block 1512 and determine not to perform post-processing of the candidate bounding box input attributes. On the other hand, if the height difference does not exceed the height difference threshold, process 1500 may also proceed to block 1516 and determine to perform post-processing of the candidate bounding box input attributes. As discussed above, the height and width difference thresholds can be configured to detect whether the candidate bounding box has undergone a rapid change in size. If it is determined that the candidate bounding box has undergone a rapid change in size, it may be determined not to perform the post-processing so that the output bounding box can track the rapid movement.

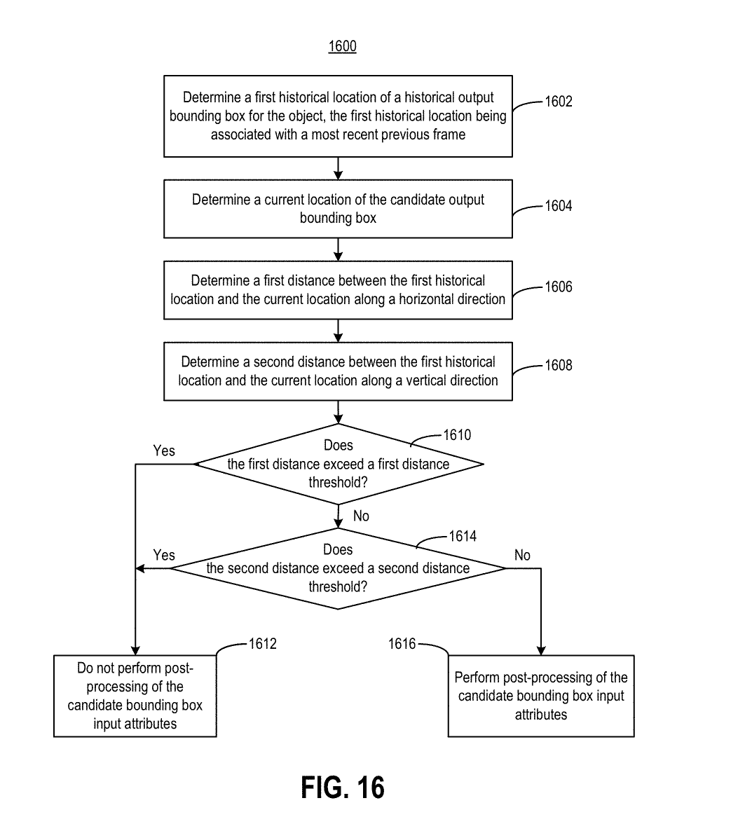

FIG. 16 is a flow chart illustrating an example of an object tracking process 1600 for one or more video frames using the techniques disclosed herein. Process 1600 can be part of block 1206 of FIG. 12 for determining whether to post-process the input attributes of candidate bounding box. Process 1600 includes, at block 1602, determining a first historical location of a historical output bounding box for the object, the first historical location being associated with a most recent previous frame. The first historical location can be obtained from, for example, an output bounding box history buffer (e.g., output bounding box history buffer 1004) that stores historical attributes of the output bounding box for an object tracker. Process 1600 further includes, at block 1604, determining a current location of the candidate output bounding box. Process 160 further includes, at block 1606, determining a first distance between the first historical location and the current location along a horizontal direction, and at block 1608, determining a second distance between the first historical location and the current location along a vertical direction. The first and second distance can reflect a current rate of movement of the candidate bounding box along, respectively, the horizontal and vertical directions.

Process 1600 further includes, at block 1610, determining whether the first distance exceeds a first distance threshold. If the first distance (along the horizontal direction) exceeds the first distance threshold, process 1600 may proceed to block 1612 and determine not to perform post-processing of the candidate bounding box input attributes. If the first distance does not exceed the first distance threshold, process 1600 may proceed to block 1614 to determine whether the second distance (along the vertical direction) exceeds a second distance threshold. If the second distance (along the vertical direction) exceeds the second distance threshold, process 1600 may proceed to block 1612 and determine not to perform post-processing of the candidate bounding box input attributes. On the other hand, if the second distance does not exceed the second distance threshold, process 1600 may also proceed to block 1616 and determine to perform post-processing of the candidate bounding box input attributes. As discussed above, the first and second distance thresholds can be a fixed value (e.g., 10) and configured to detect whether the candidate bounding box has undergone a rapid movement. If it is determined that the candidate bounding box has undergone a rapid movement, it may be determined not to perform the post-processing so that the output bounding box can track the rapid movement.

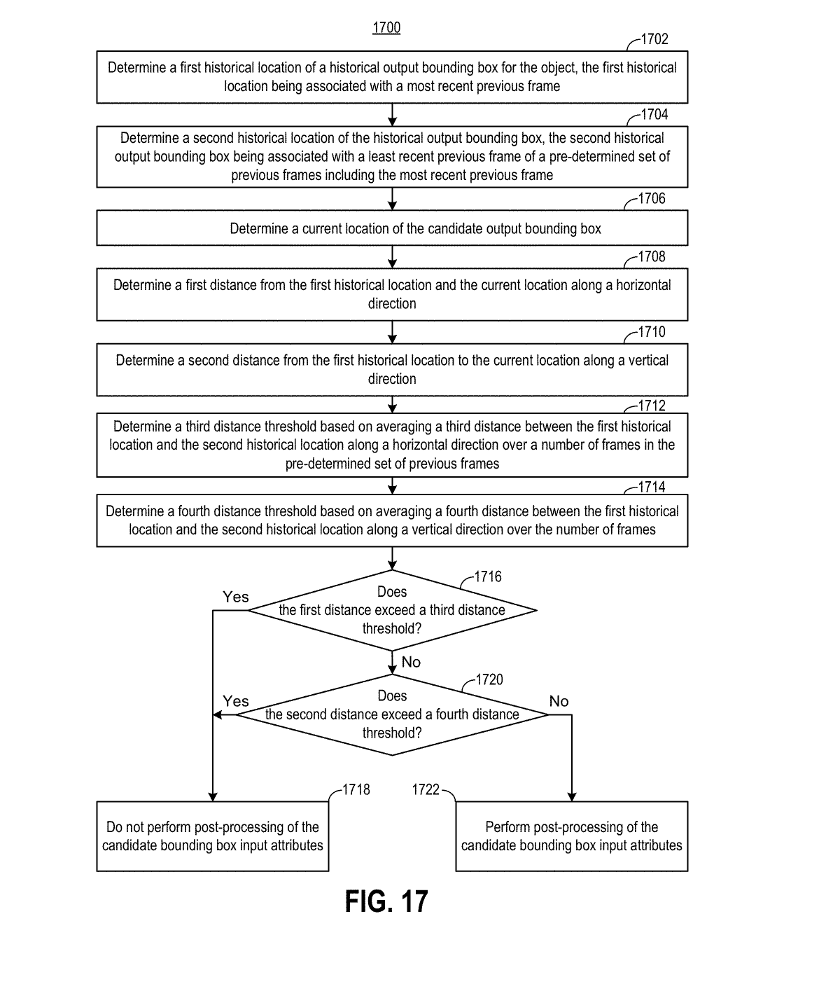

FIG. 17 is a flow chart illustrating an example of an object tracking process 1700 for one or more video frames using the techniques disclosed herein. Process 1700 can be part of block 1206 of FIG. 12 for determining whether to post-process the input attributes of candidate bounding box. Process 1700 includes, at block 1702, determining a first historical location of a historical output bounding box for the object, the first historical location being associated with a most recent previous frame, and at block 1704, determining a second historical location of the historical output bounding box, the second historical output bounding box being associated with a least recent previous frame of a pre-determined set of previous frames including the most recent previous frame. The first and second historical locations can be obtained from, for example, an output bounding box history buffer (e.g., output bounding box history buffer 1004) that stores historical attributes of the output bounding box for an object tracker. Process 1700 further includes, at block 1706, determining a current location of the candidate output bounding box. The current location can be determined based on input attributes of the candidate output bounding box. Process 1700 further includes, at block 1708, determining a first distance from the first historical location and the current location along a horizontal direction, and at block 1710, determining a second distance from the first historical location to the current location along a vertical direction. The first and second distance can reflect a current rate of movement of the candidate bounding box along, respectively, the horizontal and vertical directions.

Process 1700 further includes, at block 1712, determining a third distance threshold based on averaging a third distance between the first historical location and the second historical location along a horizontal direction over a number of frames in the pre-determined set of previous frames, and at block 1714, determining a fourth distance threshold based on averaging a fourth distance between the first historical location and the second historical location along a vertical direction over the number of frames. As discussed above, the third distance threshold and the fourth distance threshold can reflect an average rate of movement of the historical output bounding box, and can be calculated based on Equations 2 and 3 discussed above. The comparison between the current rate of movement and the historical average rate of movement can provide additional data points in judging whether the candidate bounding box has undergone a sudden and rapid movement, to the extent that the current rate of movement deviates from a historical average.

Process 1700 further includes, at block 1716, determining whether the first distance exceeds the third distance threshold. If the first distance (along the horizontal direction) exceeds the third distance threshold, process 1700 may proceed to block 1718 and determine not to perform post-processing of the candidate bounding box input attributes. If the first distance does not exceed the third distance threshold, process 1700 may proceed to block 1720 to determine whether the second distance (along the vertical direction) exceeds the fourth distance threshold. If the second distance (along the vertical direction) exceeds the fourth distance threshold, process 1700 may proceed to block 1718 and determine not to perform post-processing of the candidate bounding box input attributes. On the other hand, if the second distance does not exceed the fourth distance threshold, process 1700 may also proceed to block 1722 and determine to perform post-processing of the candidate bounding box input attributes. As discussed above, the third and fourth distance thresholds can be configured to detect whether the candidate bounding box has undergone a sudden and unexpected movement. If it is determined that the candidate bounding box has undergone such movement, it may be determined not to perform the post-processing so that the output bounding box can track the movement.

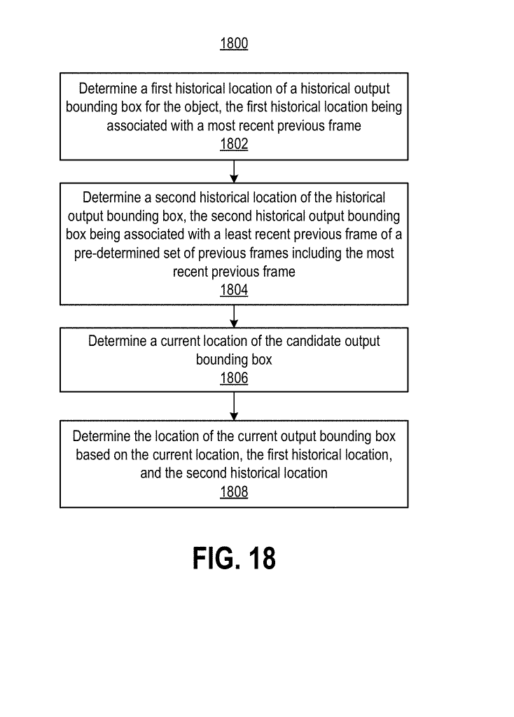

FIG. 18 is a flow chart illustrating an example of an object tracking process 1800 for one or more video frames using the techniques disclosed herein. Process 1800 can be part of block 1206 of FIG. 12 for post-processing the input attributes of candidate bounding box to generate a location for the output bounding box. Process 1800 includes, at block 1802, determining a first historical location of a historical output bounding box for the object, the first historical location being associated with a most recent previous frame. Process 1800 further includes, at block 1804, determining a second historical location of the historical output bounding box, the second historical output bounding box being associated with a least recent previous frame of a pre-determined set of previous frames including the most recent previous frame. The first and second historical locations can be determined based on information from the output bounding box history buffer, and can reflect an average rate of movement of the historical output bounding box. The first and second historical locations can be determined based on, for example, equations 4 and 7 as discussed above. Process 1800 further includes, at block 1806, determining a current location of the candidate output bounding box. The current location can be determined based on the input attributes of the candidate bounding box. Process 1800 further includes, at block 1808, determining the location of the current output bounding box based on the current location, the first historical location, and the second historical location. The location can be determined based on, for example, a weighted average of a current rate of movement of the candidate bounding box and an average rate of movement of the historical output bounding box, as discussed with respect to equations 5, 6, 8, and 9.

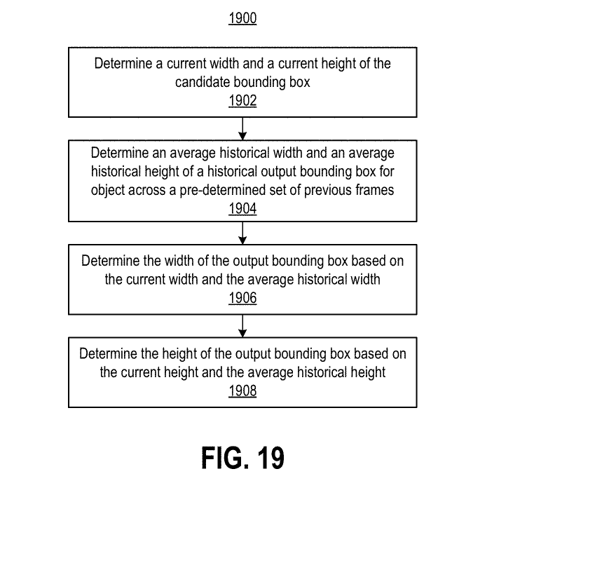

FIG. 19 is a flow chart illustrating an example of an object tracking process 1900 for one or more video frames using the techniques disclosed herein. Process 1900 can be part of block 1206 of FIG. 12 for post-processing the input attributes of candidate bounding box to generate a size (e.g., a width and a height) for the output bounding box. Process 1900 can include, at block 1902, determining a current width and a current height of the candidate bounding box. The current width and height of the candidate bounding box can be part of the input attributes of the candidate bounding box. Process 1900 can include, at block 1904, determining an average historical width and an average historical height of a historical output bounding box for object across a pre-determined set of previous frames. The average historical width and height can be determined by averaging the historical attributes of the historical bounding box stored in the output bounding box history buffer. The average historical width and average historical height can be determined based on Equations 10 and 12. Process 1900 can also include, at block 1906, determining the width of the output bounding box based on the current width and the average historical width, and at block 1908, determining the height of the output bounding box based on the current height and the average historical height. The width can be determined based on a weighted average between the current width and the average historical width, whereas the height can be determined based on the a weighted average between the current height and the average historical height, based on Equations 11 and 13.

In some examples, processes 1200-1900 may be performed by a computing device or an apparatus, such as the video analytics system 100. In one illustrative example, processes 1200-1900 can be performed by the video analytics system 600 shown in FIG. 6. In some cases, the computing device or apparatus may include a processor, microprocessor, microcomputer, or other component of a device that is configured to carry out the steps of processes 1200-1900. In some examples, the computing device or apparatus may include a camera configured to capture video data (e.g., a video sequence) including video frames. In some examples, the computing device or apparatus may include a display for displaying video frames and/or images. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Processes 1200-1900 are illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, processes 1200-1900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

Various test conditions are described below and objective simulation results are shown in Table 1 and Table 2 in order to illustrate results of the techniques discussed herein. Simulations are done by utilizing the so-called VAM report (which has been upgraded recently) to include criteria such as object level true positive rate, false positive rate, maximum delay per video clip, and average delay over all objects per video clip. Conventional VIRAT video clips were used for Table 1 and other video clips were used for Table 2. All of the video clips are well labeled and the VAM report compares the results (as tracked bounding boxes) with the marked ground truth. All 32 of the VIRAT video clips can be used for the professional security case, while the “other” dataset including 28 video clips can be used for the home security case. Both datasets range from easy to difficult video clips.

As shown in Table 1, maintaining a same true positive rate and a same false positive rate, the proposed techniques are able to improve the smoothness of the bounding box. The measurement of smoothness in Table 1 decreases with better smoothing performance, and vice versa. Within a group of 60 video clips, the smoothness of 56 video clips have been improved with the proposed techniques.

TABLE 1
Results for VIRAT Dataset

| | Object level | | |
|---|---|---|---|
| Conventional | true positive | Object level false | |
| video clips | rate (%) | positive rate (%) | Smoothness |
| Anchor | 92.039 | 4.463 | 84.013 |
| Proposed | 92.039 | 4.463 | 80.252 |

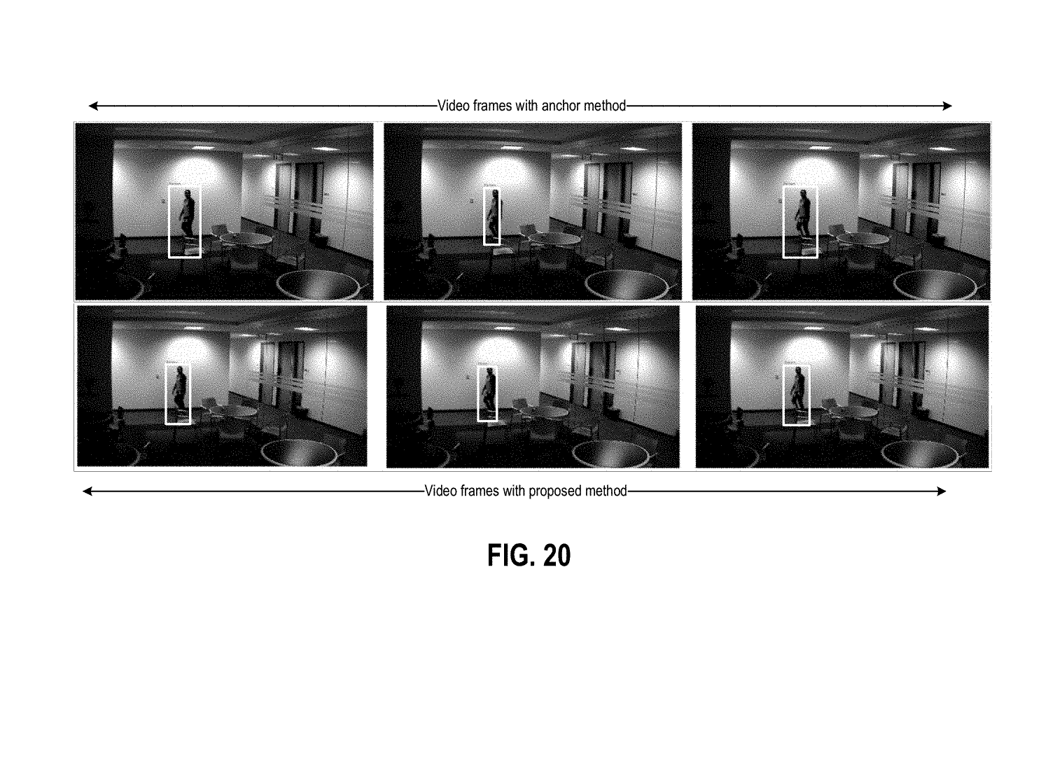

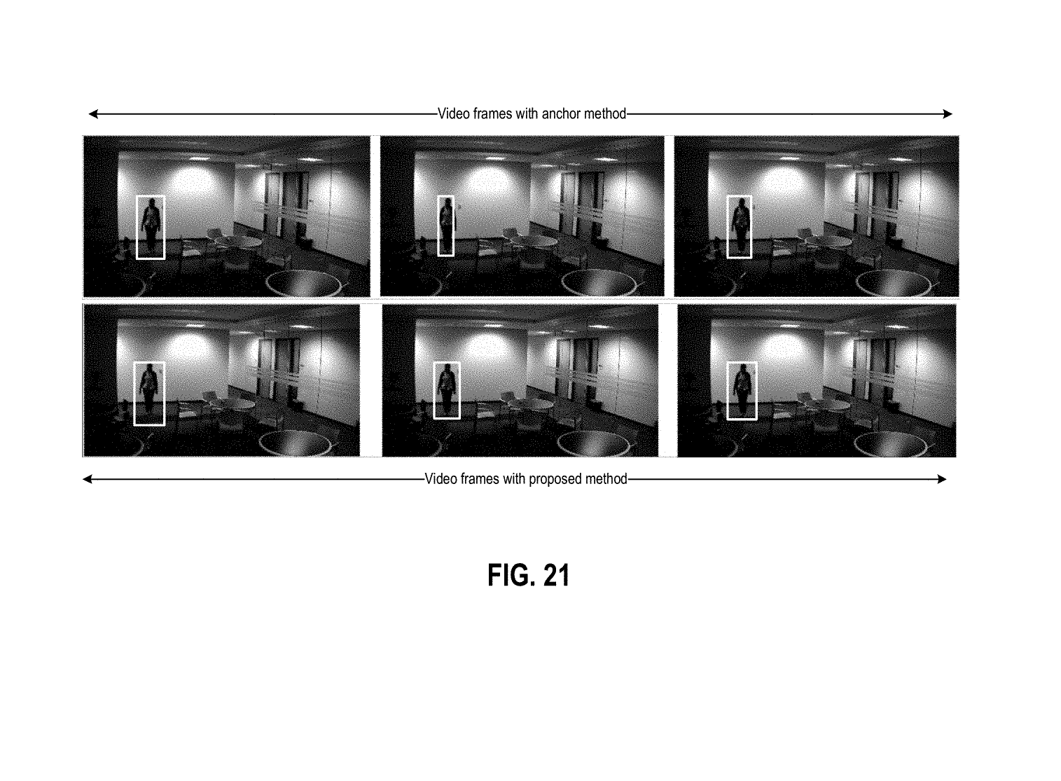

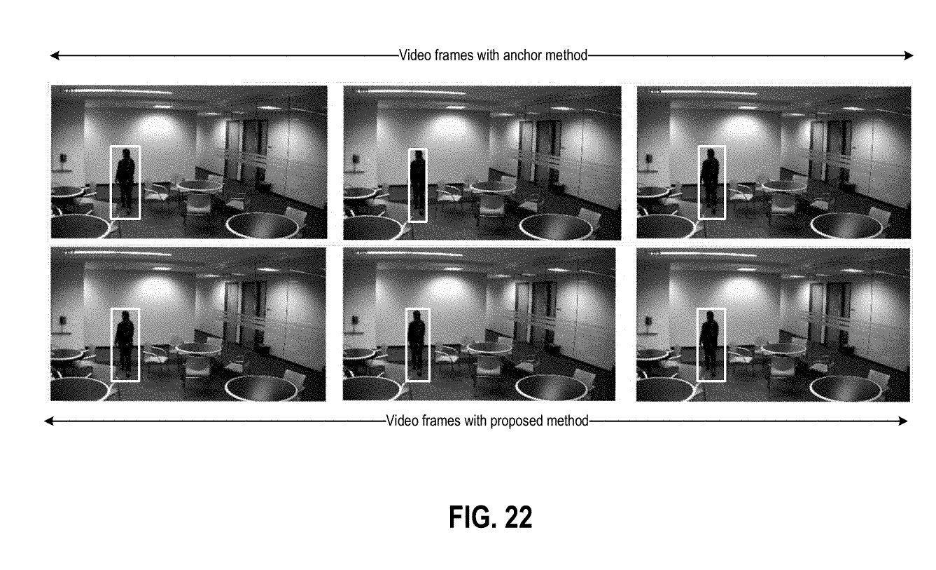

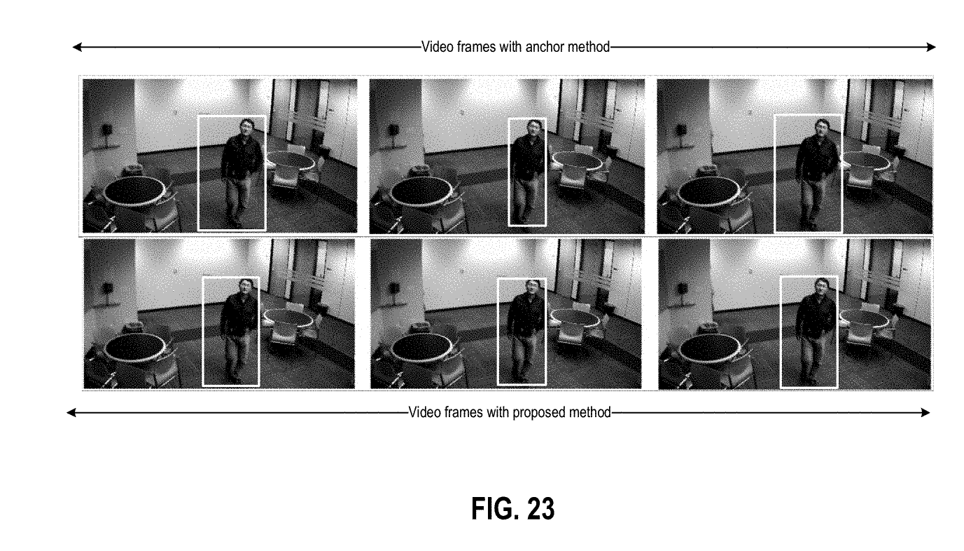

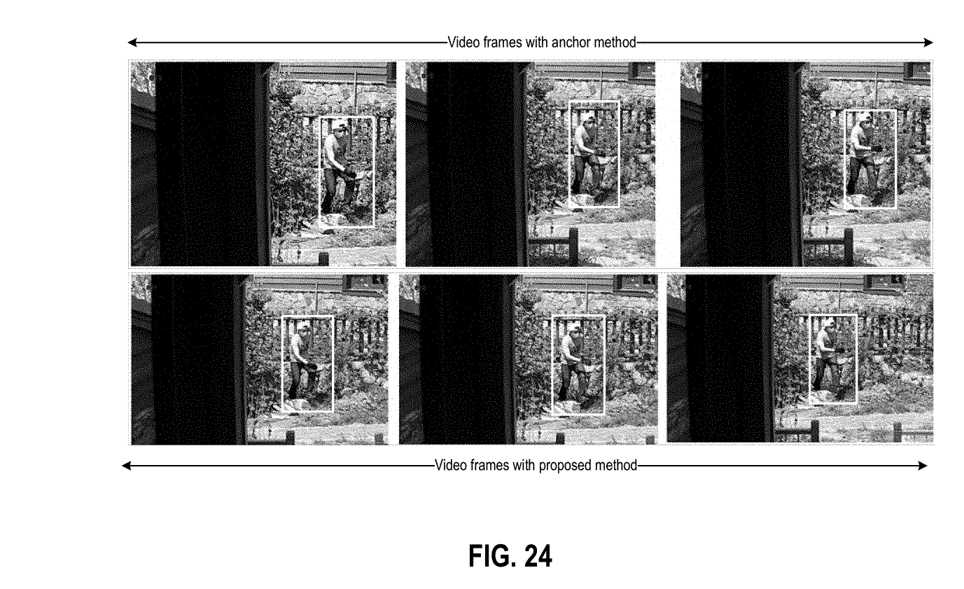

Subjective results of the techniques discussed herein are described below with respect to FIG. 20-FIG. 24. Each figure shows a set of three video frames with the bounding boxes generated with the anchor method and a set of three video frames with the bounding boxes generated with the proposed techniques. In each figure, the bounding box size changes much more smoothly (e.g., much less) in the set of video frames processed with the proposed techniques than the set of video frames processed with the anchor method. In each figure, the size of the bounding box in the second frame varies (with respect to the first frame and the third frame) much more with the anchor method than with the proposed techniques.

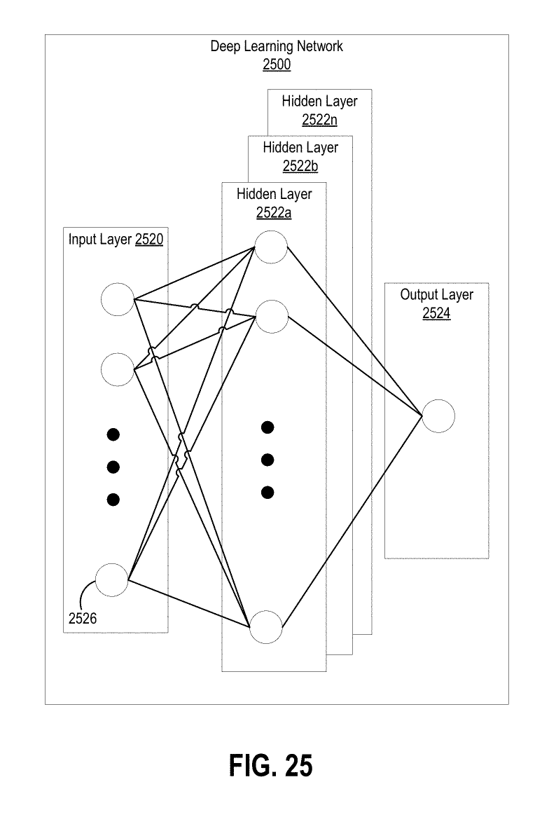

FIG. 25 is an illustrative example of a deep learning neural network 2500 that can be used by complex object detector 608. An input layer 2520 includes input data. In one illustrative example, the input layer 2520 can include data representing the pixels of an input video frame. The deep learning network 2500 includes multiple hidden layers 2522a, 2522b, through 2522n. The hidden layers 2522a, 2522b, through 2522n include “n” number of hidden layers, where “n” is an integer greater than or equal to one. The number of hidden layers can be made to include as many layers as needed for the given application. The deep learning network 2500 further includes an output layer 2524 that provides an output resulting from the processing performed by the hidden layers 2522a, 2522b, through 2522n. In one illustrative example, the output layer 2524 can provide a classification and/or a localization for an object in an input video frame. The classification can include a class identifying the type of object (e.g., a person, a dog, a cat, or other object) and the localization can include a bounding box indicating the location of the object.

The deep learning network 2500 is a multi-layer neural network of interconnected nodes. Each node can represent a piece of information. Information associated with the nodes is shared among the different layers and each layer retains information as information is processed. In some cases, the deep learning network 2500 can include a feed-forward network, in which case there are no feedback connections where outputs of the network are fed back into itself In some cases, the network 2500 can include a recurrent neural network, which can have loops that allow information to be carried across nodes while reading in input.

Information can be exchanged between nodes through node-to-node interconnections between the various layers. Nodes of the input layer 2520 can activate a set of nodes in the first hidden layer 2522a. For example, as shown, each of the input nodes of the input layer 2520 is connected to each of the nodes of the first hidden layer 2522a. The nodes of the hidden layer 2522 can transform the information of each input node by applying activation functions to these information. The information derived from the transformation can then be passed to and can activate the nodes of the next hidden layer 2522b, which can perform their own designated functions. Example functions include convolutional, up-sampling, data transformation, and/or any other suitable functions. The output of the hidden layer 2522b can then activate nodes of the next hidden layer, and so on. The output of the last hidden layer 2522n can activate one or more nodes of the output layer 2524, at which an output is provided. In some cases, while nodes (e.g., node 2526) in the deep learning network 2500 are shown as having multiple output lines, a node has a single output and all lines shown as being output from a node represent the same output value.

In some cases, each node or interconnection between nodes can have a weight that is a set of parameters derived from the training of the deep learning network 2500. For example, an interconnection between nodes can represent a piece of information learned about the interconnected nodes. The interconnection can have a tunable numeric weight that can be tuned (e.g., based on a training dataset), allowing the deep learning network 2500 to be adaptive to inputs and able to learn as more and more data is processed.

The deep learning network 2500 is pre-trained to process the features from the data in the input layer 2520 using the different hidden layers 2522a, 2522b, through 2522n in order to provide the output through the output layer 2524. In an example in which the deep learning network 2500 is used to identify objects in images, the network 2500 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the deep neural network 2500 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the network 2500 is trained well enough so that the weights of the layers are accurately tuned.

For the example of identifying objects in images, the forward pass can include passing a training image through the network 2500. The weights are initially randomized before the deep neural network 2500 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the network 2500, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the network 2500 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as Eₜₒₜₐₗ=Σ½ (target−output)², which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The deep learning network 2200 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The deep learning network 3300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The deep learning network 3300 can include any other deep network other than a CNN, such as an autoencoder, a deep belief nets (DBNs), a Recurrent Neural Networks (RNNs), among others.

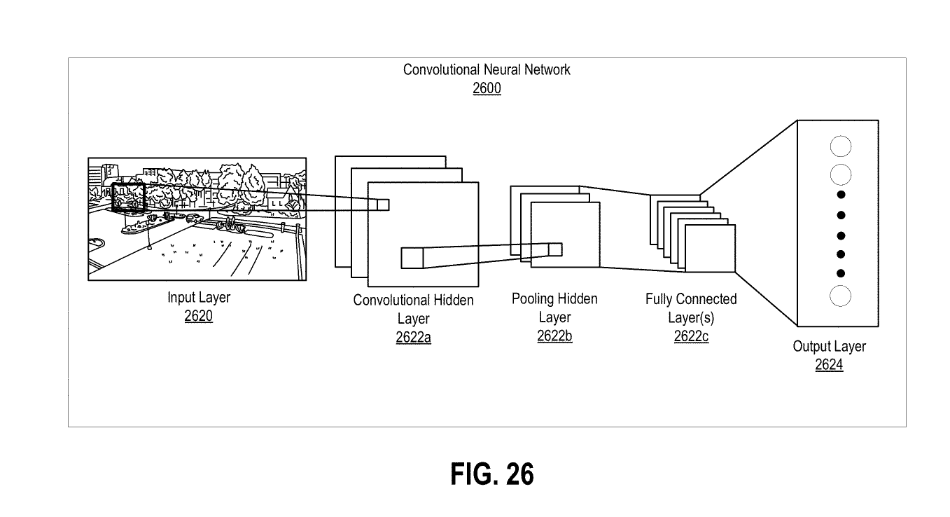

FIG. 26 is an illustrative example of a convolutional neural network 2600 (CNN 2600). The input layer 2620 of the CNN 2600 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 2622a, an optional non-linear activation layer, a pooling hidden layer 2622b, and fully connected hidden layers 2622c to get an output at the output layer 2624. While only one of each hidden layer is shown in FIG. 26, one of ordinary skill will appreciate that multiple convolutional hidden layers, non-linear layers, pooling hidden layers, and/or fully connected layers can be included in the CNN 2600. As previously described, the output can indicate a single class of an object or can include a probability of classes that best describe the object in the image.

The first layer of the CNN 2600 is the convolutional hidden layer 2622a. The convolutional hidden layer 2622a analyzes the image data of the input layer 2620. Each node of the convolutional hidden layer 2622a is connected to a region of nodes (pixels) of the input image called a receptive field. The convolutional hidden layer 2622a can be considered as one or more filters (each filter corresponding to a different activation or feature map), with each convolutional iteration of a filter being a node or neuron of the convolutional hidden layer 2622a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 2622a. Each connection between a node and a receptive field for that node learns a weight and, in some cases, an overall bias such that each node learns to analyze its particular local receptive field in the input image. Each node of the hidden layer 2622a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 2622a is due to each node of the convolutional layer being applied to its corresponding receptive field. For example, a filter of the convolutional hidden layer 2622a can begin in the top-left corner of the input image array and can convolve around the input image. As noted above, each convolutional iteration of the filter can be considered a node or neuron of the convolutional hidden layer 2622a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 2622a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 2622a.

The mapping from the input layer to the convolutional hidden layer 2622a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 2622a can include several activation maps in order to identify multiple features in an image. The example shown in FIG. 34 includes three activation maps. Using three activation maps, the convolutional hidden layer 2622a can detect three different kinds of features, with each feature being detectable across the entire image.

In some examples, a non-linear hidden layer can be applied after the convolutional hidden layer 2622a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the network 2300 without affecting the receptive fields of the convolutional hidden layer 2622a.

The pooling hidden layer 2622b can be applied after the convolutional hidden layer 2622a (and after the non-linear hidden layer when used). The pooling hidden layer 2622b is used to simplify the information in the output from the convolutional hidden layer 2622a. For example, the pooling hidden layer 2622b can take each activation map output from the convolutional hidden layer 2622a and generates a condensed activation map (or feature map) using a pooling function. Max-pooling is one example of a function performed by a pooling hidden layer. Other forms of pooling functions be used by the pooling hidden layer 2622a, such as average pooling, L2-norm pooling, or other suitable pooling functions. A pooling function (e.g., a max-pooling filter, an L2-norm filter, or other suitable pooling filter) is applied to each activation map included in the convolutional hidden layer 2622a. In the example shown in FIG. 26, three pooling filters are used for the three activation maps in the convolutional hidden layer 2622a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 2622a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 2622a having a dimension of 24×24 nodes, the output from the pooling hidden layer 2622b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 2600.

The final layer of connections in the network is a fully-connected layer that connects every node from the pooling hidden layer 2622b to every one of the output nodes in the output layer 2624. Using the example above, the input layer includes 28×28 nodes encoding the pixel intensities of the input image, the convolutional hidden layer 2622a includes 3×24×24 hidden feature nodes based on application of a 5×5 local receptive field (for the filters) to three activation maps, and the pooling layer 2622b includes a layer of 3×12×12 hidden feature nodes based on application of max-pooling filter to 2×2 regions across each of the three feature maps. Extending this example, the output layer 2624 can include ten output nodes. In such an example, every node of the 3×12×12 pooling hidden layer 2622b is connected to every node of the output layer 2624.

The fully connected layer 2622c can obtain the output of the previous pooling layer 2622b (which should represent the activation maps of high-level features) and determines the features that most correlate to a particular class. For example, the fully connected layer 2622c layer can determine the high-level features that most strongly correlate to a particular class, and can include weights (nodes) for the high-level features. A product can be computed between the weights of the fully connected layer 2622c and the pooling hidden layer 2622b to obtain probabilities for the different classes. For example, if the CNN 2600 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 2624 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

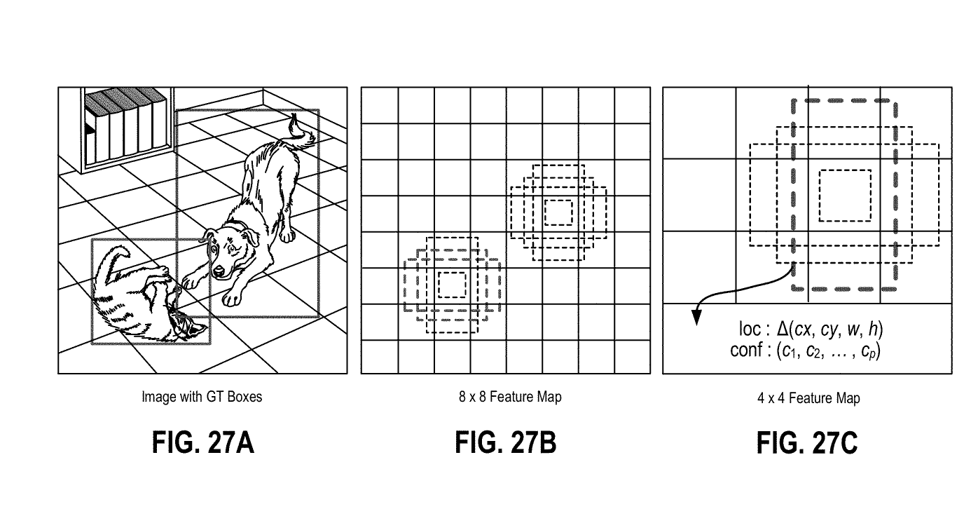

As previously noted, complex object detector system 608 can use any suitable neural network based detector. One example includes the SSD detector, which is a fast single-shot object detector that can be applied for multiple object categories or classes. The SSD model uses multi-scale convolutional bounding box outputs attached to multiple feature maps at the top of the neural network. Such a representation allows the SSD to efficiently model diverse box shapes. FIG. 27A includes an image and FIG. 27B and FIG. 27C include diagrams illustrating how an SSD detector (with the VGG deep network base model) operates. For example, SSD matches objects with default boxes of different aspect ratios (shown as dashed rectangles in FIG. 27B and FIG. 27C). Each element of the feature map has a number of default boxes associated with it. Any default box with an intersection-over-union with a ground truth box over a threshold (e.g., 0.4, 0.5, 0.6, or other suitable threshold) is considered a match for the object. For example, two of the 8×8 boxes (shown in blue in FIG. 27B) are matched with the cat, and one of the 4×4 boxes (shown in red in FIG. 27C) is matched with the dog. SSD has multiple features maps, with each feature map being responsible for a different scale of objects, allowing it to identify objects across a large range of scales. For example, the boxes in the 8×8 feature map of FIG. 27B are smaller than the boxes in the 4×4 feature map of FIG. 27C. In one illustrative example, an SSD detector can have six feature maps in total.

For each default box in each cell, the SSD neural network outputs a probability vector of length c, where c is the number of classes, representing the probabilities of the box containing an object of each class. In some cases, a background class is included that indicates that there is no object in the box. The SSD network also outputs (for each default box in each cell) an offset vector with four entries containing the predicted offsets required to make the default box match the underlying object's bounding box. The vectors are given in the format (cx, cy, w, h), with cx indicating the center x, cy indicating the center y, w indicating the width offsets, and h indicating height offsets. The vectors are only meaningful if there actually is an object contained in the default box. For the image shown in FIG. 27A, all probability labels would indicate the background class with the exception of the three matched boxes (two for the cat, one for the dog).

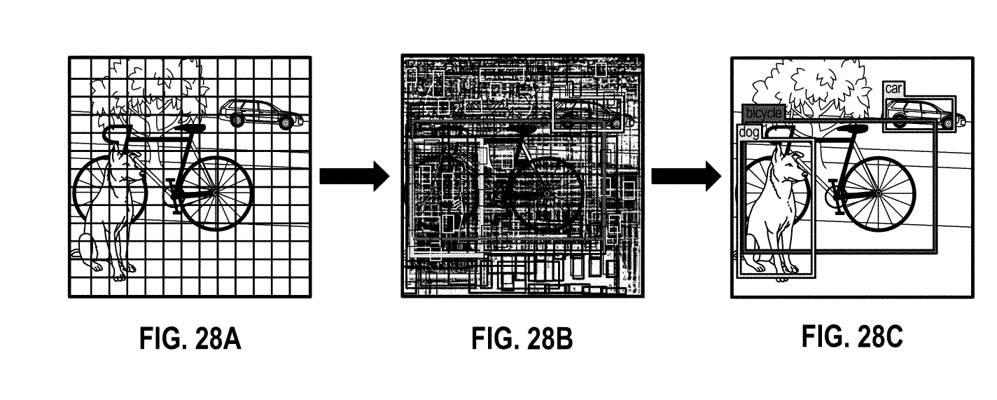

Another deep learning-based detector that can be used by complex object detector 608 to detect or classify objects in images includes the You only look once (YOLO) detector, which is an alternative to the SSD object detection system. FIG. 28A includes an image and FIG. 28B and FIG. 28C include diagrams illustrating how the YOLO detector operates. The YOLO detector can apply a single neural network to a full image. As shown, the YOLO network divides the image into regions and predicts bounding boxes and probabilities for each region. These bounding boxes are weighted by the predicted probabilities. For example, as shown in FIG. 29A, the YOLO detector divides up the image into a grid of 13-by-13 cells. Each of the cells is responsible for predicting five bounding boxes. A confidence score is provided that indicates how certain it is that the predicted bounding box actually encloses an object. This score does not include a classification of the object that might be in the box, but indicates if the shape of the box is suitable. The predicted bounding boxes are shown in FIG. 28B. The boxes with higher confidence scores have thicker borders.

Each cell also predicts a class for each bounding box. For example, a probability distribution over all the possible classes is provided. Any number of classes can be detected, such as a bicycle, a dog, a cat, a person, a car, or other suitable object class. The confidence score for a bounding box and the class prediction are combined into a final score that indicates the probability that that bounding box contains a specific type of object. For example, the yellow box with thick borders on the left side of the image in FIG. 29B is 85% sure it contains the object class “dog.” There are 169 grid cells (13×13) and each cell predicts 5 bounding boxes, resulting in 1845 bounding boxes in total. Many of the bounding boxes will have very low scores, in which case only the boxes with a final score above a threshold (e.g., above a 30% probability, 40% probability, 50% probability, or other suitable threshold) are kept. FIG. 29C shows an image with the final predicted bounding boxes and classes, including a dog, a bicycle, and a car. As shown, from the 2545 total bounding boxes that were generated, only the three bounding boxes shown in FIG. 29C were kept because they had the best final scores.

The video analytics operations discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. An apparatus for tracking one or more objects in one or more video frames, comprising:
a memory configured to store the one or more video frames; and
a processor coupled to the memory and configured to:
obtain, based on an application of an object detector to at least one key frame in the one or more video frames, a candidate bounding box for an object tracker associated with an object in a current frame, the candidate bounding box being associated with one or more input attributes, wherein the one or more input attributes include at least one of a location or a size of the candidate bounding box;
determine a set of metrics indicating a degree of change of one or more physical attributes of the object;
determine, based on the set of metrics, one or more output attributes associated with a current output bounding box, the one or more output attributes being determined based on the one or more input attributes associated with the candidate bounding box ; and
track the object in the current frame using the object tracker based on the one or more output attributes.

2. The apparatus of claim 1, wherein a key frame is a frame from the one or more video frames to which the object detector is applied.

3. The apparatus of claim 1, wherein determining the one or more output attributes associated with the current output bounding box includes selecting the one or more output attributes from the one or more input attributes associated with the candidate bounding box.

4. The apparatus of claim 3, wherein determining the set of metrics comprises determining a status of the object tracker, and wherein determining the one or more output attributes associated with the current output bounding box comprises:
determining whether the status of the object tracker satisfies a pre-determined condition; and
based on determining that a status of the object tracker does not satisfy the pre-determined condition, selecting the one or more output attributes from the one or more input attributes associated with the candidate bounding box.

5. The apparatus of claim 4, wherein the status of the object tracker comprises a recent status of the object tracker in a most recent previous frame of the one or more video frames, the most recent previous frame being associated with a historical attribute for a historical output bounding box for the object tracker, and wherein determining whether the status of the object tracker satisfies the pre-determined condition comprises determining whether the object tracker has been continuously associated with the object for at least a threshold duration before the most recent previous frame.

6. The apparatus of claim 5, wherein determining the one or more output attributes associated with the current output bounding box further comprises, based on a determination that the object tracker has not been continuously associated with the object for at least the threshold duration before the most recent previous frame, selecting the one or more output attributes from the one or more input attributes associated with the candidate bounding box.

7. The apparatus of claim 5, wherein the status of the object tracker comprises an aggregate status of the object tracker across a set of previous frames of the one or more video frames, each previous frame of the set of previous frames being associated with a historical attribute for a historical output bounding box for the object, and wherein determining whether the status of the object tracker satisfies the pre-determined condition comprises determining whether the object tracker has been continuously associated with the object across at least a requisite number of previous frames of the set of previous frames.

8. The apparatus of claim 7, wherein determining the one or more output attributes associated with the current output bounding box further comprises, based on a determination that the object tracker has not been continuously associated with the object across the requisite number of previous frames, selecting the one or more output attributes from the one or more input attributes associated with the candidate bounding box.

9. The apparatus of claim 5, wherein the processor is configured to, based on determining that the recent status of the object tracker in the most recent previous frame satisfies the pre-determined condition, store the one or more output attributes associated with the current output bounding box in a history buffer.

10. The apparatus of claim 5, wherein the processor is configured to, based on determining that the recent status of the object tracker in the most recent previous frame does not satisfy the pre-determined condition, remove the historical attribute from a history buffer.

11. The apparatus of claim 3, wherein determining the set of metrics comprises:
determining a first historical width and a first historical height of a historical output bounding box for the object tracker in a most recent previous frame of the one or more video frames; and
determining a current width and a current height of the candidate bounding box in the current frame; and
wherein determining the one or more output attributes associated with the current output bounding box comprises, based on determining at least one of a width difference between the first historical width and the current width exceeding a width difference threshold, or a height difference between the first historical height and the current height exceeding a height difference threshold, selecting the one or more output attributes from the one or more input attributes associated with the candidate bounding box.

12. The apparatus of claim 3, wherein determining the set of metrics comprises:
determining a first historical location of a historical output bounding box for the object tracker in a most recent previous frame of the one or more video frames; and
determining a current location of the candidate bounding box; and
wherein determining the one or more output attributes associated with the current output bounding box further comprises, based on determining at least one of a first distance between the first historical location and the current location along a horizontal direction exceeding a first distance threshold, or a second distance between the first historical location and the current location along a vertical direction exceeding a second distance threshold, selecting the one or more output attributes from the one or more input attributes associated with the candidate bounding box.

13. The apparatus of claim 1, wherein determining the one or more output attributes associated with the current output bounding box includes selecting the one or more output attributes from a result of post-processing of the one or more input attributes, wherein the one or more output attributes associated with the current output bounding box include at least one of an adjusted location or an adjusted size of the candidate bounding box when selected from the result of the post-processing of the one or more input attributes.

14. The apparatus of claim 13, wherein the one or more output attributes comprises a location of the current output bounding box, and wherein selecting the one or more output attributes from the result of the post-processing the candidate bounding box comprises:
determining a first historical location of a historical output bounding box for the object tracker in a most recent previous frame of the one or more video frames;
determining a second historical location of the historical output bounding box in a least recent previous frame of a pre-determined set of previous frames including the most recent previous frame;
determining a current location of the candidate bounding box; and
determining the location of the current output bounding box based on the current location, the first historical location, and the second historical location.

15. The apparatus of claim 13, wherein the one or more output attributes comprises a width and a height of the current output bounding box, and wherein determining the one or more output attributes from the result of the post-processing the candidate bounding box comprises:
determining a current width and a current height of the candidate bounding box;
determining an average historical width and an average historical height of a historical output bounding box for the object across a pre-determined set of previous frames;
determining the width of the current output bounding box based on the current width and the average historical width; and
determining the height of the current output bounding box based on the current height and the average historical height.

16. The apparatus of claim 1, wherein the processor is further configured to detect a blob in the current frame using background subtraction, the blob including pixels of at least a portion of the object in the current frame, wherein tracking the object in the current frame includes tracking the blob using the object tracker based on the one or more output attributes.

17. The apparatus of claim 1, wherein the object detector comprises a feature-based detector.

18. The apparatus of claim 1, wherein the object detector is based on a trained classification network.

19. The apparatus of claim 1, wherein the object detector comprises a feature-based detector based on a trained classification network, and wherein the object in the current frame is detected using the object detector.

20. The apparatus of claim 1, further comprising a camera configured to capture the one or more video frames.

21. A method of tracking objects in one or more video frames, the method comprising:
obtaining, based on an application of an object detector to at least one key frame in the one or more video frames, a candidate bounding box for an object tracker associated with an object in a current frame, the candidate bounding box being associated with one or more input attributes, wherein the one or more input attributes include at least one of a location or a size of the candidate bounding box;
determining a set of metrics indicating a degree of change of one or more physical attributes of the object;
determining, based on the set of metrics, one or more output attributes associated with a current output bounding box, the one or more output attributes being determined based on the one or more input attributes associated with the candidate bounding box; and
tracking the object in the current frame using the object tracker based on the one or more output attributes.

22. The method of claim 21, wherein a key frame is a frame from the one or more video frames to which the object detector is applied.

23. The method of claim 21, wherein determining the one or more output attributes associated with the current output bounding box includes selecting the one or more output attributes from the one or more input attributes associated with the candidate bounding box.

24. The method of claim 23, wherein determining the set of metrics comprises determining a status of the object tracker, and wherein determining the one or more output attributes associated with the current output bounding box comprises:
determining whether the status of the object tracker satisfies a pre-determined condition; and
based on determining that a status of the object tracker does not satisfy the pre-determined condition, selecting the one or more output attributes from the one or more input attributes associated with the candidate bounding box.

25. The method of claim 24, wherein the status of the object tracker comprises a recent status of the object tracker in a most recent previous frame of the one or more video frames, the most recent previous frame being associated with a historical attribute for a historical output bounding box for the object tracker, and wherein determining whether the status of the object tracker satisfies the pre-determined condition comprises determining whether the object tracker has been continuously associated with the object for at least a threshold duration before the most recent previous frame.

26. The method of claim 25, wherein determining the one or more output attributes associated with the current output bounding box further comprises, based on a determination that the object tracker has not been continuously associated with the object for at least the threshold duration before the most recent previous frame, selecting the one or more output attributes from the one or more input attributes associated with the candidate bounding box.

27. The method of claim 24, further comprising, based on determining that the recent status of the object tracker in the most recent previous frame satisfies the pre-determined condition, store the one or more output attributes of the current output bounding box in a history buffer.

28. The method of claim 21, wherein determining the one or more output attributes associated with the current output bounding box includes selecting the one or more output attributes from a result of post-processing of the one or more input attributes, wherein the one or more output attributes associated with the current output bounding box include at least one of an adjusted location or an adjusted size of the candidate bounding box when selected from the result of the post-processing of the one or more input attributes.

29. The method of claim 28, wherein the one or more output attributes comprises a location of the current output bounding box, and wherein selecting the one or more output attributes from the result of the post-processing the candidate bounding box comprises:
determining a first historical location of a historical output bounding box for the object tracker in a most recent previous frame of the one or more video frames;
determining a second historical location of the historical output bounding box in a least recent previous frame of a pre-determined set of previous frames including the most recent previous frame;
determining a current location of the candidate bounding box; and
determining the location of the current output bounding box based on the current location, the first historical location, and the second historical location.

30. The method of claim 28, wherein the one or more output attributes comprises a width and a height of the current output bounding box, and wherein determining the one or more output attributes from the result of the post-processing the candidate bounding box comprises:
determining a current width and a current height of the candidate bounding box;
determining an average historical width and an average historical height of a historical output bounding box for the object across a pre-determined set of previous frames;
determining the width of the current output bounding box based on the current width and the average historical width; and
determining the height of the current output bounding box based on the current height and the average historical height.
